(19) United States
(12) Patent Application Publication
(10) Pub. No.: US 2022/0286973 A1
(43) Pub. Date: Sep. 8, 2022

(54) USER TERMINAL AND RADIO COMMUNICATION METHOD

(71) Applicant: NTT DOCOMO, INC., Tokyo (JP)

(72) Inventors: Yuki Takahashi, Tokyo (JP); Shohei Yoshioka, Tokyo (JP); Satoshi Nagata, Tokyo (JP); Lihui Wang, Beijing (CN); Xiaolin Hou, Beijing (CN)

(73) Assignee: NTT DOCOMO, INC., Tokyo (JP)

(21) Appl. No.: 17/608,102

(22) PCT Filed: May 2, 2019
(86) PCT No.: PCT/JP2019/018186

§ 371 Date: Nov. 1, 2021

(51) Int. Cl. H04W 52/14

(52) U.S. Cl. CPC H04W 52/146; H04W 16/14

(57) ABSTRACT

A user terminal according to one aspect of the present disclosure includes: a receiving section that receives first downlink control information and second downlink control information, the first downlink control information including a first transmit power control command for a first type uplink channel, and the second downlink control information including a second transmit power control command for a second type uplink channel; and a control section that, in a case where a transmission timing of the second downlink control information is later than a transmission timing of the first downlink control information, and a transmission timing of the first type uplink channel is later than a transmission timing of the second type uplink channel, controls accumulation of the first transmit power control command and the second transmit power control command based on at least one of an uplink channel type, a power control adjustment state index, a downlink control information transmission timing and an uplink channel transmission timing.

### TECHNICAL FIELD

The present disclosure relates to a user terminal and a radio communication method of a next-generation mobile communication system.

### BACKGROUND ART

In Universal Mobile Telecommunications System (UMTS) networks, for the purpose of higher data rates and lower latency, Long Term Evolution (LTE) has been specified (Non-Patent Literature 1). Furthermore, for the purpose of a larger capacity and higher sophistication than those of LTE (Third Generation Partnership Project (3GPP) Releases (Rel.) 8 and 9), LTE-Advanced (3GPP Rel. 10 to 14) has been specified.

LTE successor systems (also referred to as, for example, the 5th generation mobile communication system (5G), 5G+(plus), New Radio (NR) or 3GPP Rel. 15 or subsequent releases) are also studied.

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8)”, April 2010

### SUMMARY OF INVENTION

### Technical Problem

It is studied for a future radio communication system (e.g., NR) to introduce Out-Of-Order (OOO) processing.

However, according to a current specification, study on control in a case where out-of-order is applied (e.g., transmit power control at a time of application of out-of-order) has not sufficiently advanced. In a case where processing at a time of application of out-of-order is not appropriately performed, there is a risk that, for example, communication quality deteriorates.

It is therefore one of objects of the present disclosure to provide a user terminal and a radio communication method that can appropriately perform out-of-order processing.

### Solution to Problem

A user terminal according to one aspect of the present disclosure includes: a receiving section that receives first downlink control information and second downlink control information, the first downlink control information including a first transmit power control command for a first type uplink channel, and the second downlink control information including a second transmit power control command for a second type uplink channel; and a control section that, in a case where a transmission timing of the second downlink control information is later than a transmission timing of the first downlink control information, and a transmission timing of the first type uplink channel is later than a transmission timing of the second type uplink channel, controls accumulation of the first transmit power control command and the second transmit power control command based on at least one of an uplink channel type, a power control adjustment state index, a downlink control information transmission timing and an uplink channel transmission timing.

### Advantageous Effects of Invention

According to one aspect of the present disclosure, it is possible to appropriately perform out-of-order processing.

### BRIEF DESCRIPTION OF DRAWINGS

FIG. 1 is a diagram illustrating one example of out-of-order processing.

FIG. 2 is a diagram illustrating another example of the out-of-order processing.

FIG. 3 is a diagram for explaining a task of transmit power control of the out-of-order processing.

FIGS. 4A and 4B are diagrams illustrating one example of a case of the out-of-order processing.

FIG. 5 is a diagram illustrating one example of transmit power control according to a first aspect.

FIGS. 6A and 6B are diagrams illustrating one example of transmit power control according to a second aspect.

FIG. 7 is a diagram illustrating another example of the transmit power control according to the second aspect.

FIGS. 8A and 8B are diagrams illustrating one example of transmit power control according to a third aspect.

FIGS. 9A and 9B are diagrams illustrating one example of transmit power control according to a fourth aspect.

FIGS. 10A and 10B are diagrams illustrating another example of the transmit power control according to the fourth aspect.

FIG. 11 is a diagram illustrating one example of a schematic configuration of a radio communication system according to one embodiment.

FIG. 12 is a diagram illustrating one example of a configuration of a base station according to the one embodiment.

FIG. 13 is a diagram illustrating one example of a configuration of a user terminal according to the one embodiment.

FIG. 14 is a diagram illustrating one example of hardware configurations of the base station and the user terminal according to the one embodiment.

### DESCRIPTION OF EMBODIMENTS

(Processing Time)

According to legacy Rel-15 NR, for example, a processing time of a downlink shared channel (Physical Downlink Shared Channel (PDSCH)) and a processing time of an uplink shared channel (Physical Uplink Shared Channel (PUSCH)) are defined. In addition, the processing time may be read as, for example, a preparation time, a preparation procedure time and a processing procedure time.

The processing time of the PDSCH may be a duration to an Uplink (UL) symbol subsequent to an end of a last symbol of the PDSCH for conveying a transport block. A UE may provide transmission acknowledgement information (e.g., Hybrid Automatic Repeat reQuest ACKnowledgement (HARQ-ACK)) that is the same as the UL symbol or is valid in a symbol subsequent to this UL symbol.

The processing time of the PUSCH may be a duration to a UL symbol subsequent to an end of a last symbol of a downlink control channel (Physical Downlink Control Channel (PDCCH)) for conveying Downlink Control Information (DCI) for scheduling the PUSCH. The UE may transmit a PUSCH in a symbol that is the same as the UL symbol or subsequent to this UL symbol.

The processing time of the PDSCH may be determined based on a parameter N₁ (that may be referred to as a PDSCH decoding time). The processing time of the PUSCH may be determined based on a parameter N₂ (that may be referred to as a PUSCH preparation time).

N₁ may be determined based on a downlink SCS in which the PDSCH has been transmitted, and an SCS of a UL channel (e.g., PUSCH or a PUSCH) in which the above HARQ-ACK is transmitted. For example, N₁ may be determined based on a minimum SCS of these SCSs, and may be decided as 8 to 20 symbols such as 8 symbols in a case where, for example, the minimum SCS is 15 kHz. N₁ may be decided as 13 to 24 symbols in a case where an additional PDSCH DMRS is configured.

N₂ may be determined based on a downlink SCS in which the PDCCH for conveying DCI for scheduling the PUSCH has been transmitted, and an SCS of a UL channel in which the PUSCH is transmitted. For example, N₂ may be determined based on a minimum SCS of these SCSs, and may be decided as 10 to 36 symbols such as 10 symbols in a case where, for example, the minimum SCS is 15 kHz.

That is, the above processing time (and the parameters (such as N₁ and N₂) related to the processing time) may conform to a value specified by a numerology associated with the minimum SCS among a PDCCH/PDSCH and a PUCCH/PUSCH.

When transmitting HARQ-ACK associated with a PDSCH by using a PUSCH, the UE may transmit the PUSCH in a UL symbol subsequent to a time (a sum of times) obtained by adding a processing time of the above PDSCH and a processing time of the above PUSCH, or in a symbol subsequent to this UL symbol.

According to legacy Rel-15 NR, the above-described processing time is classified into two of a processing time for UE capability 1 and a processing time for UE capability 2. The processing time for the UE capability 2 is shorter than the processing time for the UE capability 1.

The UE can report whether or not the UE supports the UE capability 2 for each of the PDSCH and the PUSCH to a network (e.g., base station) by using different pieces of UE capability information (e.g., the former is an RRC parameter “pdsch-ProcessingType2” and the latter is an RRC parameter “pusch-ProcessingType2”). UE capability X for a PDSCH (or a PUSCH) may be referred to as PDSCH (or PUSCH) processing capability X.

Based on the UE capability information, the base station may determine whether or not the UE performs processing based on the UE capability 2. The base station may configure information (e.g., the former is a parameter “processingType2Enabled” included in an RRC information element “PDSCH-ServingCellConfig”, and the latter is a parameter “processingType2Enabled” included in an RRC information element “PUSCH-ServingCellConfig”) that indicates that the UE capability 2 is applied (enabled) to each of the PDSCH and the PUSCH. In addition, the former parameter may be referred to as “Capability2-PDSCH-Processing”, or the latter parameter may be referred to as “Capability2-PUSCH-Processing”.

In addition, in the present disclosure, a higher layer signaling may be one or a combination of, for example, a Radio Resource Control (RRC) signaling, a Medium Access Control (MAC) signaling and broadcast information.

The MAC signaling may use, for example, an MAC Control Element (MAC CE) or an MAC Protocol Data Unit (PDU). The broadcast information may be, for example, a Master Information Block (MIB), a System Information Block (SIB), a Remaining Minimum System Information (RMSI) and Other System Information (OSI).

In addition, even when the UE supports the UE capability 2 and the base station configures application of the UE capability 2 to the UE, the UE falls back to the UE capability 1 under given conditions. When, for example, a subcarrier spacing for the PDSCH is 30 kHz (a parameter μ=1 related to a numerology), and the number of resource blocks to be scheduled exceeds 136, the UE processes the PDSCH based on the processing time of the UE capability 1.

On the other hand, a condition of fallback to the UE capability 1 for the PUSCH is not defined in the specification of legacy Rel-15 NR.

(Out-Of-Order Processing)

Processing of receiving a given signal or channel (that may be expressed as a signal/channel) and transmitting/receiving another signal/channel associated with the received signal/channel will be studied. A case where, until first processing that is the above processing is started and finished, another second processing that is the above processing is started and finished is also referred to as Out-Of-Order (OOO) processing since start-to-end orders of these processing are reversed. According to NR, introduction of this 000 processing is studied.

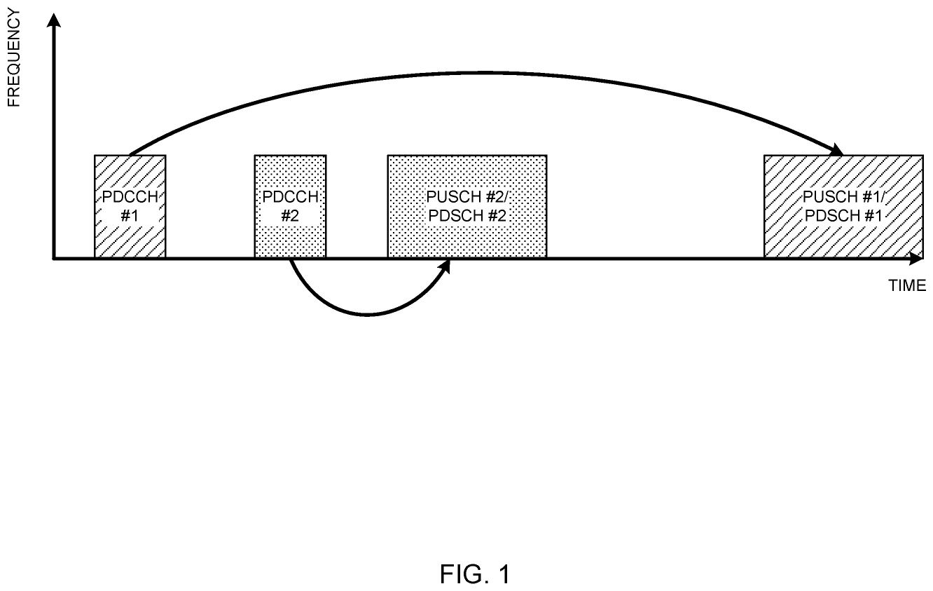

FIG. 1 is a diagram illustrating another example of OOO processing. In this case, the above-described first processing corresponds to processing of receiving a PDCCH #1, and transmitting a PUSCH #1 associated with the PDCCH #1 or receiving a corresponding PDSCH #1. The above-described second processing corresponds to processing of receiving a PDCCH #2, and transmitting a PUSCH #2 associated with the PDCCH #2 or receiving a corresponding PDSCH #2.

In this example, a time between the PDCCH #1 and the PUSCH #1/PDSCH #1 is significantly greater than a time between the PDCCH #2 and the PUSCH #2/PDSCH #2, and the first processing and the second processing are 000. More specifically, the PUSCH #2/PDSCH #2 associated with the PDCCH #2 received after the PDCCH #1 is transmitted/received before the PUSCH #1/PDSCH #1 associated with the PDCCH #1.

In addition, a PUSCH #X/PDSCH #X according to the present disclosure may be read as at least one of the PUSCH #X and the PDSCH #X.

The OOO processing as illustrated in FIG. 1 relates to scheduling of a PUSCH/PDSCH, and therefore may be referred to as, for example, OOO scheduling or an OOO PUSCH/PDSCH.

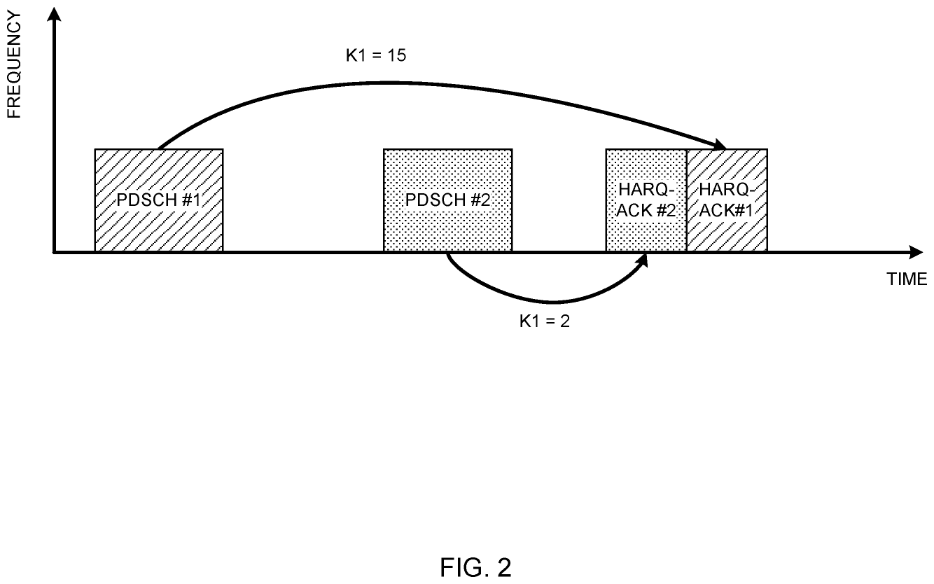

FIG. 2 is a diagram illustrating one example of OOO processing. In this example, the above-described first processing corresponds to processing of receiving a first PDSCH (PDSCH #1), and transmitting first HARQ-ACK (HARQ-ACK #1) associated with the PDSCH #1. The above-described second processing corresponds to processing of receiving a second PDSCH (PDSCH #2), and transmitting second HARQ-ACK (HARQ-ACK #2) associated with the PDSCH #2.

K1 illustrated in FIG. 2 represents a parameter that indicates a transmission timing of HARQ-ACK associated with the received PDSCH, and may be determined based on DCI for scheduling the PDSCH (e.g., may be indicated by a PDSCH-to-HARQ-timing-indicator field).

In this example, K1 (=15) between the PDSCH #1 and the HARQ-ACK #1 is significantly greater than K1 (=2) between the PDSCH #2 and the HARQ-ACK #2, and the first processing and the second processing are 000. More specifically, the HARQ-ACK #2 associated with the PDSCH #2 received after the PDSCH #1 is transmitted before the HARQ-ACK #1 associated with the PDSCH #1.

The OOO processing as illustrated in FIG. 2 may be referred to as an OOO PDSCH-HARQ-ACK flow or OOO HARQ-ACK since HARQ-ACK orders associated with PDSCH orders are reversed.

Generally, in order of reception of signals/channels, signals/channels associated with the received signals/channels are preferably transmitted/received. On the other hand, necessity for the OOO processing increases when a plurality of services (that may be referred to as, for example, use cases or communication types) of different requirements are used.

For example, a high speed and a large volume (e.g., enhanced Mobile Broad Band (eMBB)), massive terminals (e.g., massive Machine Type Communication (mMTC)), and ultra reliability and low latency (e.g., Ultra Reliable and Low Latency Communications (URLLC)) are studied as the use cases of NR.

For example, a case is assumed where, in above-described FIG. 1, the PUSCH #1 or the PDSCH #1 is eMBB data and the PUSCH #2 or the PDSCH #2 is URLLC data (the URLLC data having higher importance interrupts the eMBB data).

(UL Transmit Power Control)

According to NR, transmission power of a PUSCH or a PUCCH is controlled based on power control information indicated by a value of a given field (also referred to as, for example, a TPC command field or a first field) in DCI. The power control information may be referred to as a TPC command (also referred to as, for example, a value, an increase/decrease value and a correction value).

TPC used for PUSCH transmission may be independently configured per BWP, carrier or serving cell. Furthermore, a TPC command value may be a value associated with bit information notified by a given DCI format. The bit information notified by the given DCI format and the value associated with the bit information may be defined in a table in advance.

Furthermore, a TPC command indicated by DCI to each of PUSCH or PUCCH transmission may be accumulated (tpc-accumulation). Whether or not to accumulate TPC commands may be configured to the UE by the network (e.g., base station). The base station may notify the UE of whether or not to accumulate the TPC commands by using a higher layer signaling (e.g., tpc-Accummlation).

In a case where accumulation of TPC commands is applied (enabled), the UE may determine transmission power by taking into account a TPC command associated with a PUSCH in a given range (or notified by a PDCCH or DCI). Furthermore, a TPC command may be included in one of power control adjustment state parameters (e.g., part of a given numerical expression) defined by the given numerical expression.

In this regard, whether the power control adjustment state includes a plurality of states (e.g., 2 states) or includes a single state may be configured by a higher layer parameter. Furthermore, in a case where a plurality of power control adjustment states are configured, one of a plurality of these power control adjustment states may be identified based on an index 1 (e.g., 1∈{0, 1}). A power control adjustment state may be referred to as, for example, a PUSCH power control adjustment state or a first or second state.

Alternatively, a power control adjustment state index may be determined based on information notified by DCI. The UE may separately control accumulation of TPC commands per power control adjustment state index. In a case where, for example, a plurality of power control adjustment state indices are configured, the UE may perform transmit power control (e.g., accumulation of TPC commands) per index.

Thus, NR supports a method for determining transmission power by taking into account (e.g., accumulating) a TPC command notified for each UL channel (e.g., PUCCH or PUSCH) transmission. On the other hand, in a case where out-of-order where transmission processing of a given PUSCH and transmission processing of another PUSCH are performed by reversing start-to-end orders of these transmission processing, how to control transmission power (e.g., accumulation of TPC commands or determination of a power control adjustment state) matters.

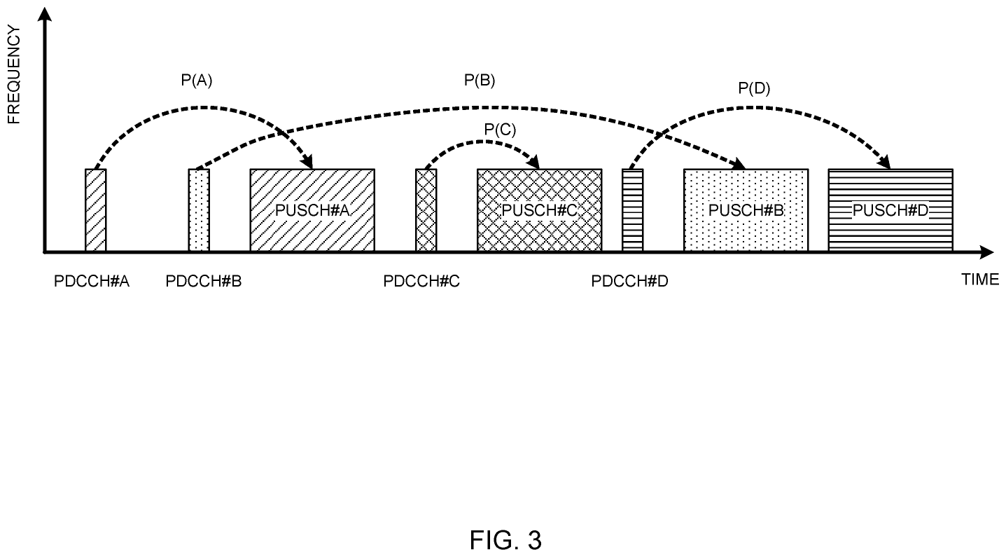

When, for example, a plurality of PUSCHs #A to #D are transmitted as illustrated in FIG. 3, a case also occurs where a transmission order of PDCCHs #A to #D (or DCI) for scheduling each PUSCH, and a transmission order of the PUSCHs #A to #D respectively scheduled by the PDCCH #A to #D are different. However, a current specification has not sufficiently advanced study on, for example, transmit power control in a case where out-of-order is applied. When the control is not appropriately performed, there is a risk that, for example, communication quality deteriorates.

Hence, the inventors of the present disclosure have studied a method for appropriately controlling transmission power of UL transmission in a case where out-of-order is applied, and reached the present invention.

An embodiment according to the present disclosure will be described in detail below with reference to the drawings. Each aspect may be each applied alone or may be applied in combination. The following description will describe a UL channel (or UL physical channel) citing an uplink shared channel (e.g., PUSCH) as an example. However, the same may apply to an uplink control channel, too. For example, a PUSCH may be read as a PUCCH and applied in the following description.

(Out-of-Order Application Case)

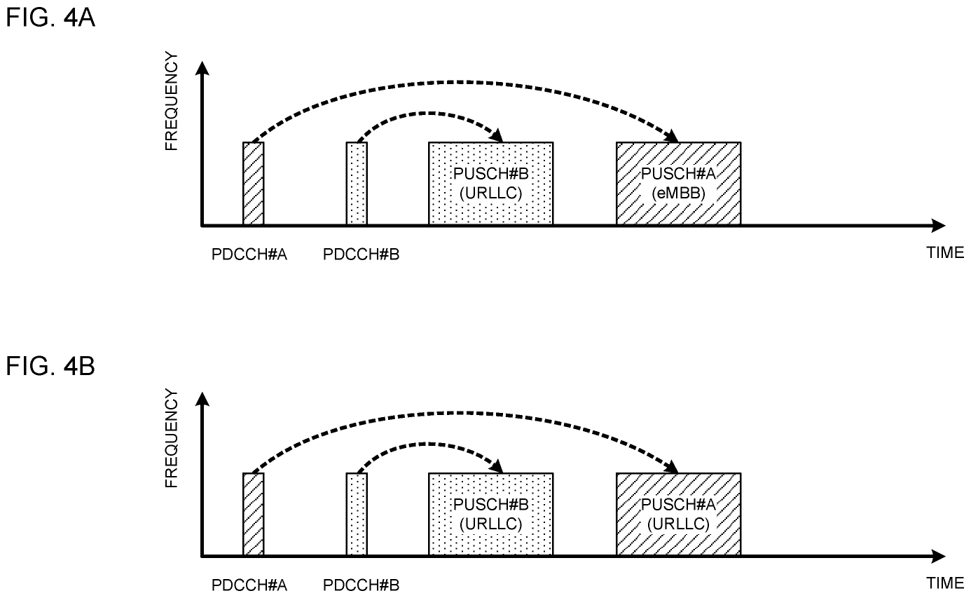

For example, following case 1 or 2 is assumed as an out-of-order application case. Case 1 indicates a case where out-of-order processing is applied to PUSCH transmission of different use cases (or traffic types) (see FIG. 4A), and case 2 indicates a case where out-of-order processing is applied to PUSCH transmission of the same use case (see FIG. 4B).

FIG. 4A illustrates a case where a transmission timing of the PDCCH #A (or DCI #A) is earlier than a transmission timing of the PDCCH #B (or DCI #B), yet a transmission timing of the PUSCH #A is later than a transmission timing of the PUSCH #B. The PDCCH #A (or DCI #A) is used to schedule the PUSCH #A for eMBB, and the PDCCH #B (or DCI #B) is used to schedule the PUSCH #B for URLCC.

That is, until transmission processing of the PUSCH #A is started and finished, transmission processing of the another PUSCH #B is started and finished, and start-to-end orders of these processing are reversed.

In FIG. 4B, the PDCCH #A (or DCI #A) is used to schedule the PUSCH #A for URLLC, and the PDCCH #B (or DCI #B) is used to schedule the PUSCH #B for URLCC.

The following description is applicable to each of out-of-order in a case where a use case is the same and in a case where use cases are different. In addition, the use case is not limited to eMBB and URLLC, and may be applied to other use cases (e.g., at least one of mMTC, IoT, Industrial Internet of Things (IIoT and industrial IoT) and eURLLC).

(First Aspect)

According to the first aspect, accumulation of TPC commands is controlled separately per UL channel transmission type.

A UL channel type may be classified based on a use case (or traffic type). For example, first type UL channel transmission may be associated with eMBB, and second type UL channel transmission may be associated with URLLC. A UE may decide a use case based on a given parameter (e.g., at least one of notification that uses DCI, an RNTI type to be applied to CRC scrambling and an MCS table type to be applied), and control accumulation of TPC commands.

Alternatively, the UL channel type may be classified based on a power control adjustment state index (e.g., 1). For example, a first use case (e.g., eMBB) may be associated with a first power adjustment state, and a second use case (e.g., URLLC) may be associated with a second power adjustment state. Alternatively, given PUSCH transmission of the same use case may be associated with the first power adjustment state, and another PUSCH transmission may be associated with the second power adjustment state.

In a case where the power control adjustment state (e.g., 1∈{0, 1}) is configured, a power control adjustment state index of a TPC command associated with the first type UL channel may be set as 0, and a power control adjustment state index of a TPC command associated with the second type UL channel may be set as 1. In addition, a value of 1 is not limited to two values, and may be three or more values (e.g., 0, 1, 2 and 3). Alternatively, instead of allocating different values of the power control adjustment state 1 to UL channels of different types, different power control adjustment states (e.g., “1” and “1”) may be allocated.

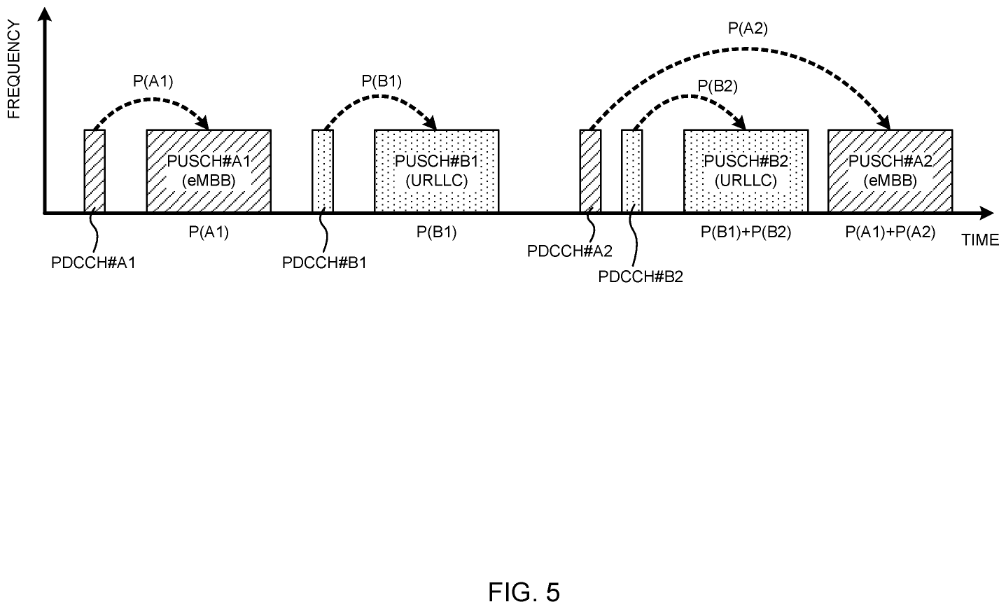

The UE applies accumulation of a TPC command #A (corresponding to, for example, a power control adjustment state #A) included in a PDCCH #A associated with first type PUSCH (also referred to as a PUSCH #A below) transmission only to transmission of the PUSCH #A (see FIG. 5). Similarly, the UE applies accumulation of a TPC command #B (corresponding to, for example, a power control adjustment state #A) included in a PDCCH #B associated with second type PUSCH (also referred to as a PUSCH #B below) transmission only to transmission of the PUSCH #B (see FIG. 5).

That is, the UE may perform control to not accumulate the TPC command #A and the TPC command #B.

FIG. 5 illustrates one example of transmit power control (e.g., TPC command accumulation method) in a case where the first type PUSCH #A and the second type PUSCH #B are transmitted. In this regard, FIG. 5 illustrates a case where, after transmission processing of a PUSCH #A1 and transmission processing of a PUSCH #B1 are performed in forward start-to-end orders of these transmission processing (in-order), transmission processing of a PUSCH #A2 and transmission processing of a PUSCH #B2 are performed by reversing start-to-end orders of these transmission processing (out-of-order).

The UE may decide a PUSCH type based on an indication from DCI, an RNTI type to be applied to CRC scrambling of a PDCCH and an MCS table type to be applied to scheduling of a PUSCH, and decide accumulation of TPC commands.

For example, the UE may decide that a PUSCH scheduled by a PDCCH CRC-scrambled by a C-RNTI is the PUSCH #A for eMBB, and a PUSCH scheduled by a PDCCH CRC-scrambled by a CS-RNTI is the PUSCH #B for URLLC. Furthermore, the UE may decide that a PUSCH scheduled by a given MCS table (e.g., a new 64 QAM MCS table) is the PUSCH #A for eMBB, and a PUSCH scheduled by another MCS table is the PUSCH #B for URLLC.

Alternatively, the UE may decide accumulation of TPC commands based on a power control adjustment state index associated with a PUSCH (or a TPC command). The power control adjustment state index may be notified to the UE by at least one of downlink control information and a higher layer signaling.

In FIG. 5, the UE determines transmission power for the PUSCH #A1 based on power control information (e.g., TPC command P (A1)) included in the PDCCH #A1. Furthermore, the UE determines transmission power for the PUSCH #B1 based on power control information (e.g., TPC command P (B1)) included in the PDCCH #B1. In this case, the UE performs control to not accumulate the TPC commands P (A1) as transmission power of the PUSCH #B1.

The UE determines transmission power for the PUSCH #B2 based on power control information (e.g., TPC command P (B2)) included in the PDCCH #B2, and the TPC command P (B1) that has already been obtained. That is, the UE performs control to accumulate the TPC commands P (B1) and P (B2) as the transmission power of the PUSCH #B2, and to not accumulate the TPC commands P (A1) and P (A2).

The UE determines transmission power for the PUSCH #A2 based on power control information (e.g., TPC command P (B2)) included in the PDCCH #A2, and the TPC command P (A1) that has already been obtained. That is, the UE performs control to accumulate the TPC commands P (A1) and P (A2) as the transmission power of the PUSCH #A2, and to not accumulate the TPC commands P (B1) and P (B2).

Thus, by controlling accumulation of TPC commands according to PUSCH types, it is possible to separately control transmit power control per transmission type (or use case).

(Second Aspect) According to the second aspect, a type of a TPC command that are accumulated is separately configured according to a UL channel type. Hereinafter, a case where only a TPC command for a first type UL channel is accumulated for first type UL channel transmission, and a TPC command for a second type UL channel and, in addition, a TPC command for another type UL channel are accumulated for second type UL channel transmission will be described. In addition, for example, classification of a UL channel type and a decision method may be controlled similar to the first aspect.

A UE determines transmission power for the first type PUSCH #A by accumulating a TPC command #A (corresponding to, for example, a power control adjustment state #A) included in a PDCCH #A for scheduling a PUSCH #A. On the other hand, the UE may determine transmission power for the second type PUSCH #B by accumulating a TPC command #B (corresponding to, for example, a power control adjustment state #B) included in a PDCCH #B for scheduling a PUSCH #B and, in addition, the TPC command #A.

That is, the UE performs control to not accumulate the TPC command #A and the TPC command #B for the given type PUSCH #A, and permits accumulation of the TPC command #A and the TPC command #B for the another type PUSCH #B. The UE may control based on given conditions whether or not to accumulate the TPC command #A in a case where transmission power of the PUSCH #B is determined. In addition, whether or not to permit accumulation of TPC commands for another type may be defined by a specification in advance, or may be configured to the UE by, for example, a higher layer signaling.

The given condition may be at least one of a PUSCH transmission timing, a PDCCH (or DCI) transmission timing and whether or not to apply out-of-order. Hereinafter, cases (cases 2-1 to 2-3) where whether or not to accumulate the TPC command #A is determined based on the given condition when the transmission power of the PUSCH #B is determined will be described.

<Case 2-1>

The UE may accumulate TPC commands included in PDCCHs (including the PDCCH #A, too) whose transmission timings are earlier than that of the PUSCH #B, and determine the transmission power of the PUSCH #B.

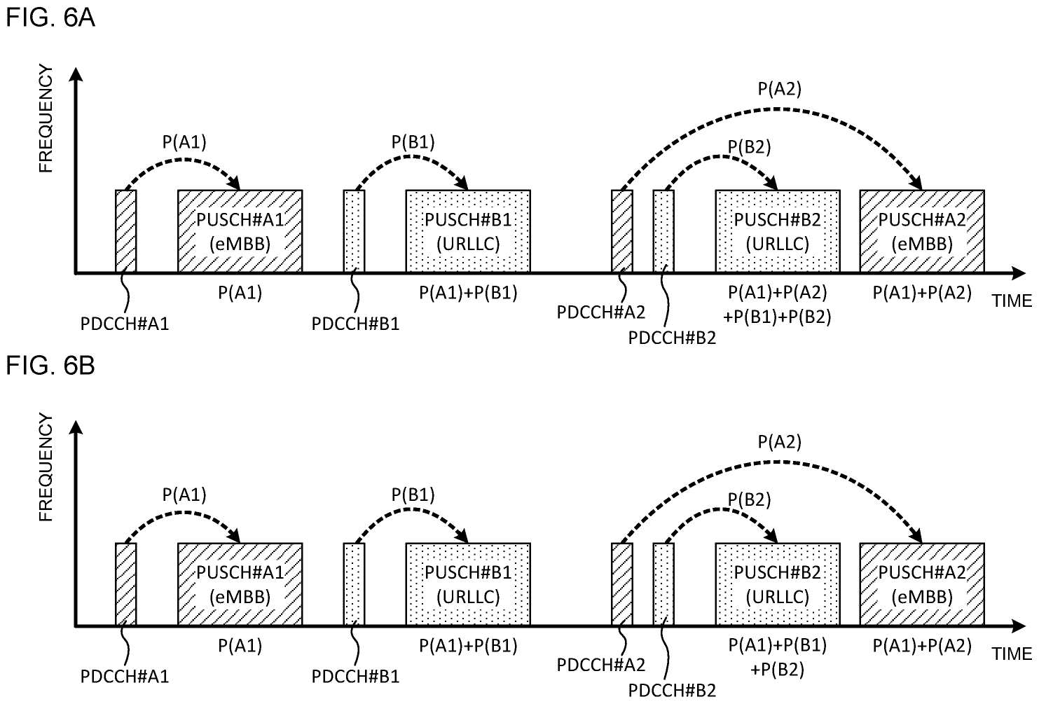

FIG. 6A illustrates one example of transmit power control (e.g., TPC command accumulation method) in a case where the first type PUSCH #A and the second type PUSCH #B are transmitted. In this regard, FIG. 6A illustrates a case where, after transmission processing of a PUSCH #A1 and transmission processing of a PUSCH #B1 are performed in forward start-to-end orders of these transmission processing (in-order), transmission processing of a PUSCH #A2 and transmission processing of a PUSCH #B2 are performed by reversing start-to-end orders of these transmission processing (out-of-order).

The UE determines transmission power for the PUSCH #A1 based on power control information (e.g., TPC command P (A1)) included in a PDCCH #A1. Furthermore, the UE determines transmission power for the PUSCH #B1 by taking into account the TPC command P (A1) and power control information (e.g., TPC command P (B1)) included in a PDCCH #B1.

In FIG. 6A, a transmission timing of a PDCCH #A2 for scheduling the PUSCH #A2 is earlier than a transmission timing of the PUSCH #B2. The UE may determine transmission power for the PUSCH #B2 by taking into account accumulation of TPC commands included in PDCCHs (PDCCHs #A1, #B1, #A2 and #B2) transmitted earlier than the PUSCH #B. In this regard, FIG. 6A illustrates a case where the transmission power of the PUSCH #B2 is determined by taking into account accumulation of the TPC commands P (A1), P (B1), P (A2) and P (B2).

The UE determines transmission power for the PUSCH #A2 based on power control information (e.g., TPC command P (A2)) included in the PDCCH #A2, and the TPC command P (A1) that has already been obtained. That is, the UE performs control to accumulate the TPC commands P (A1) and P (A2) as the transmission power of the PUSCH #A2, and to not accumulate the TPC commands P (B1) and P (B2).

Thus, by controlling TPC commands that are accumulated according to PUSCH types, it is possible to separately control transmit power control per transmission type (or use case). There is also assumed, for example, an environment in which a channel (e.g., URLLC PUSCH) having a higher priority occurs only in a sporadic manner. In this case, it is possible to appropriately configure transmission power for URLLC that is generated in a sporadic manner by accumulating for a PUSCH of URLLC a TPC command for eMBB. On the other hand, by not accumulating for a PUSCH of eMBB a TPC command that supports URLLC, it is possible to determine transmission power for eMBB without being influenced by a TPC command for URLLC that is generated in a sporadic manner.

<Case 2-2>

The UE may accumulate a TPC command included in a PDCCH (including the PDCCH #A, too) for scheduling a PUSCH whose transmission timing is earlier than that of the PUSCH #B, and determine the transmission power of the PUSCH #B. That is, case 2-2 adopts a condition that not only the transmission timing of the PDCCH but also the transmission timing of the PUSCH scheduled by the PDCCH are earlier than that of the PUSCH #B in case 2-1.

FIG. 6B illustrates one example of transmit power control (e.g., TPC command accumulation method) in a case where the first type PUSCH #A and the second type PUSCH #B are transmitted. In this regard, FIG. 6B illustrates a case where, after transmission processing of the PUSCH #A1 and transmission processing of the PUSCH #B1 are performed in forward start-to-end orders of these transmission processing (in-order), transmission processing of the PUSCH #A2 and transmission processing of the PUSCH #B2 are performed by reversing start-to-end orders of these transmission processing (out-of-order).

In FIG. 6B, transmit power control (e.g., accumulation of TPC commands) of the PUSCH #A1, the PUSCH #B1 and the PUSCH #A2 may be performed similar to case 2-1.

In FIG. 6B, a transmission timing of the PDCCH #A2 for scheduling the PUSCH #A2 is earlier than a transmission timing of the PUSCH #B2, yet a transmission timing of the PUSCH #A2 is later than a transmission timing of the PUSCH #B2. The UE may determine transmission power for the PUSCH #B2 by taking into account accumulation of a TPC command included in the PDCCH #B2 and, in addition, a TPC command included in a PDCCH for scheduling a PUSCH (e.g. PUSCH #A1) whose transmission timing is earlier than that of the PUSCH #B2. In this regard, FIG. 6B illustrates a case where the transmission power of the PUSCH #B2 is determined by taking into account accumulation of P (B2) and, in addition, the TPC commands P (A1) and P (B1). On the other hand, the TPC command P (A2) for the PUSCH #A2 is not taken into account.

Thus, by controlling TPC commands that are accumulated according to PUSCH types, it is possible to separately control transmit power control per transmission type (or use case). Furthermore, by controlling whether or not to accumulate a TPC command based on a transmission timing of a PUSCH, it is possible to secure a duration of the PDCCH #A2 and the PUSCH #B2 to some degree, so that it is possible to suppress a UE processing load.

<Case 2-3>

The UE may determine whether or not to accumulate the TPC command #A when determining transmission power of given type PUSCH (e.g., PUSCH #B) transmission based on whether or not to apply out-of-order where transmission processing of the PUSCH #A and transmission processing of the PUSCH #B are performed by reversing start-to-end orders of these transmission processing.

When, for example, performing the transmission processing of the PUSCH #A and the transmission processing of the PUSCH #B by reversing the start-to-end orders of these transmission processing (out-of-order), the UE may determine the transmission power of the given type PUSCH (e.g., PUSCH #B) by taking into account a TPC command for an another type PUSCH (e.g., PUSCH #A), too. On the other hand, when performing the transmission processing of the PUSCH #A and the transmission processing of the PUSCH #B in forward start-to-end orders of these transmission processing (in-order), the UE may determine the transmission power of the given type PUSCH #B without taking into account a TPC command for the another type PUSCH #A.

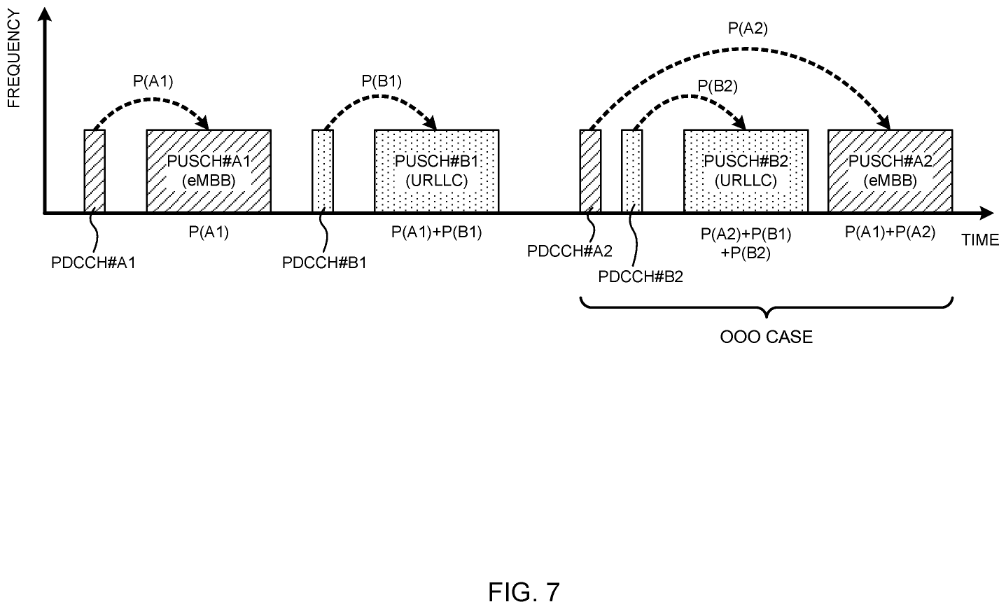

FIG. 7 illustrates one example of transmit power control (e.g., TPC command accumulation method) in a case where the first type PUSCH #A and the second type PUSCH #B are transmitted. In this regard, FIG. 7 illustrates a case where, after transmission processing of a PUSCH #A1 and transmission processing of a PUSCH #B1 are performed in forward start-to-end orders of these transmission processing (in-order), transmission processing of the PUSCH #A2 and transmission processing of the PUSCH #B2 are performed by reversing start-to-end orders of these transmission processing (out-of-order).

The UE determines transmission power for the PUSCH #A1 based on power control information (e.g., TPC command P (A1)) included in the PDCCH #A1. Furthermore, the UE determines transmission power for the PUSCH #B1 based on power control information (e.g., TPC command P (B1)) included in the PDCCH #B1. That is, the UE performs control to not take into account (or accumulate) the TPC command P (A1) for another type during transmit power control of the PUSCH #B1 at a time of in-order processing.

In FIG. 7, the transmission processing of the PUSCH #A2 and the transmission processing of the PUSCH #B2 are performed by reversing the start-to-end orders of these transmission processing (application of out-of-order). The UE controls transmission power for the PUSCH #B2 by taking into account a TPC command P (B2) included in the PDCCH #B2 and the TPC command P (B1) for the same transmission type and, in addition, the TPC command P (A2) for the PUSCH #A2 to which out-of-order is applied.

The UE determines transmission power for the PUSCH #A2 based on power control information (e.g., TPC command P (A2)) included in the PDCCH #A2, and the TPC command P (A1) that has already been obtained. That is, the UE performs control to accumulate the TPC commands P (A1) and P (A2) as the transmission power of the PUSCH #A2, and to not accumulate the TPC commands P (B1) and P (B2) associated with other types.

In addition, the above description has described the case where the UE accumulates the TPC command #A for PUSCH #B transmission at a time of application of out-of-order. However, the present disclosure is not limited to this. The UE may perform control to accumulate the TPC command #A for the PUSCH #B transmission at a time of application of in-order, and to not accumulate the TPC command #A for the PUSCH #B transmission at a time of application of out-of-order.

<Variation>

Above cases 2-1 to 2-3 have described the cases where transmission power is determined for the second type PUSCH #B by taking into account (e.g., accumulating) TPC commands, too, associated with the another type (e.g., first type) PUSCH #A. However, the present disclosure is not limited to this. For example, application of the TPC command #A to the PUSCH #B may be controlled based on a configuration of TPC commands associated with the first type PUSCH #A and the second type PUSCH #2.

In a case where, for example, a configuration of the TPC command associated with the first type PUSCH #A and a configuration of the TPC command associated with the second type PUSCH #B are commonly configured to the UE, the UE determines transmission power for the PUSCH #B by taking into account the TPC command associated with the PUSCH #A (case 2-1 to 2-3). On the other hand, in a case where, for example, the configuration of the TPC command associated with the first type PUSCH #A and the configuration of the TPC command associated with the second type PUSCH #B are separately configured to the UE, the UE may be configured to not take into account for the PUSCH #B the TPC command associated with the PUSCH #A.

The configuration of the TPC command may be at least one of a TPC command value, a range and a table to be defined. For example, a case is assumed where a range of the TPC command associated with the second type PUSCH #B is configured wider than a range of the TPC command associated with the first type PUSCH #B.

In this case, the UE may be configured to not take into account for the PUSCH #B the TPC command associated with the PUSCH #A (see, for example, FIG. 5).

Thus, in a case where configurations of TPC commands are separately configured for PUSCH transmission of different types, it is possible to flexibly control transmit power control per transmission type (or use case) by controlling accumulation of TPC commands according to a PUSCH type.

(Third Aspect) According to the third aspect, types of TPC commands that are accumulated are separately configured according to a UL channel type. Hereinafter, a case where a TPC command for first type UL channel and, in addition, a TPC command for another type UL channel are accumulated for first type UL channel transmission, and only a TPC command for a second type UL channel is accumulated for second type UL channel transmission will be described. In addition, for example, classification of a UL channel type and a decision method may be controlled similar to the first aspect.

A UE determines transmission power for the second type PUSCH #B by accumulating a TPC command #B (corresponding to, for example, a power control adjustment state #B) included in a PDCCH #B for scheduling a PUSCH #B. On the other hand, the UE may determine transmission power for the first type PUSCH #A by accumulating a TPC command #A (corresponding to, for example, a power control adjustment state #A) included in a PDCCH #A for scheduling a PUSCH #A and, in addition, the TPC command #B.

That is, the UE permits accumulation of the TPC command #A and the TPC command #B for the given type PUSCH #A, and performs control to not accumulate the TPC command #A and the TPC command #B for the another type PUSCH #B. The UE may control based on given conditions whether or not to accumulate the TPC command #B in a case where transmission power of the PUSCH #A is determined. In addition, whether or not to permit accumulation of TPC commands for another type may be defined by a specification in advance, or may be configured to the UE by, for example, a higher layer signaling.

The given condition may be at least one of a PUSCH transmission timing, a PDCCH (or DCI) transmission timing and whether or not to apply out-of-order. Cases (cases 3-1 and 3-2) where whether or not to accumulate the TPC command #B is determined based on the given condition when the transmission power of the PUSCH #A is determined will be described.

<Case 3-1>

The UE may accumulate TPC commands included in PDCCHs (including the PDCCH #B, too) whose transmission timings are earlier than that of the PUSCH #A, and determine the transmission power of the PUSCH #A.

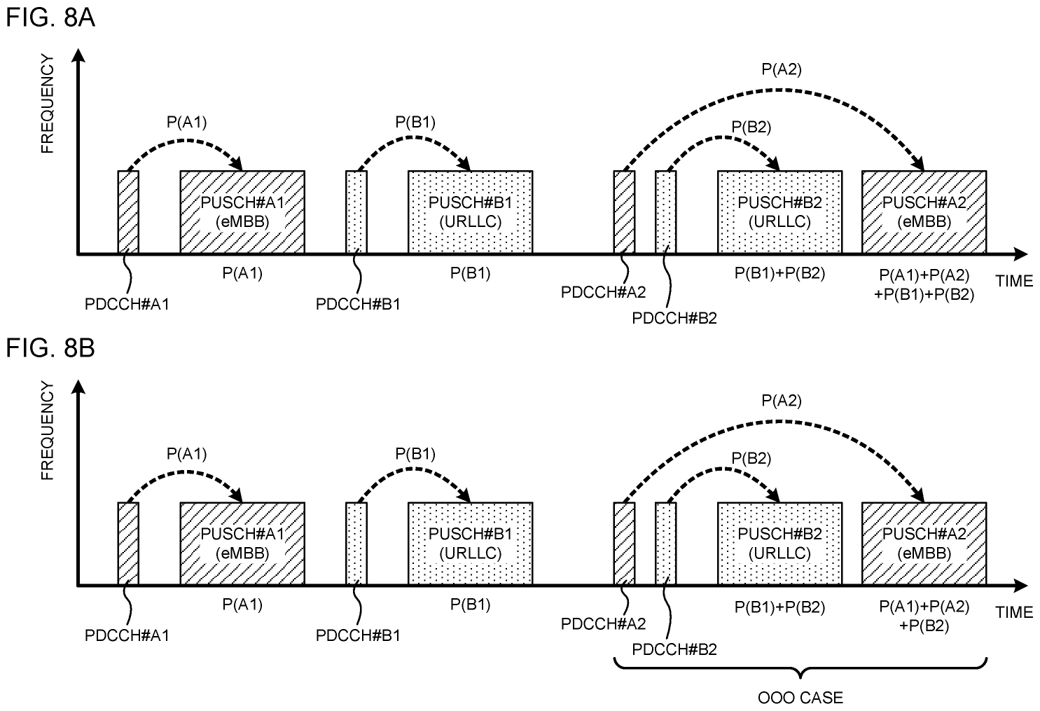

FIG. 8A illustrates one example of transmit power control (e.g., TPC command accumulation method) in a case where the first type PUSCH #A and the second type PUSCH #B are transmitted. In this regard, FIG. 8A illustrates a case where, after transmission processing of a PUSCH #A1 and transmission processing of a PUSCH #B1 are performed in forward start-to-end orders of these transmission processing (in-order), transmission processing of a PUSCH #A2 and transmission processing of a PUSCH #B2 are performed by reversing start-to-end orders of these transmission processing (out-of-order).

The UE determines transmission power for the PUSCH #A1 based on power control information (e.g., TPC command P (A1)) included in a PDCCH #A1. Furthermore, the UE determines transmission power for the PUSCH #B1 based on power control information (e.g., TPC command P (B1)) included in a PDCCH #B1.

In this case, the UE performs control to not accumulate the TPC command P (A1)) for another type as transmission power of the PUSCH #B1. In addition, there is no PUCCH #B that is transmitted earlier than the PUSCH #A1 in this case, and therefore the TPC command for the PUSCH #B is not taken into account as transmission power of the PUSCH #A1. If there is the PUCCH #B that is transmitted earlier than the PUSCH #A1, the transmission power of the PUSCH #A may be determined by taking into account the TPC command included in the PUCCH #B, too.

The UE may determine transmission power for the PUSCH #B2 by taking into account accumulation of the TPC command P (B2) included in the PDCCH #B2 for scheduling the PUSCH #B2 and a TPC command for the same type (P (B1) in this case) that has already been obtained. That is, the UE performs control to not accumulate the TPC commands P (A1) and P (A2) as the transmission power of the PUSCH #B2.

In FIG. 8A, a transmission timing of a PDCCH #B2 for scheduling the PUSCH #B2 is earlier than a transmission timing of the PUSCH #A2. The UE may determine transmission power for the PUSCH #A2 by taking into account accumulation of TPC commands included in PDCCHs (PDCCHs #A1, #B1, #A2 and #B2) transmitted earlier than the PUSCH #A2. In this regard, FIG. 8A illustrates a case where the transmission power of the PUSCH #A2 is determined by taking into account accumulation of the TPC commands P (A1), P (B1), P (A2) and P (B2).

Thus, by controlling TPC commands that are accumulated according to PUSCH types, it is possible to separately control transmit power control per transmission type (or use case).

<Case 3-2>

The UE may determine whether or not to accumulate the TPC command #B for another type when determining transmission power of given type PUSCH (e.g., PUSCH #A) transmission based on whether or not to apply out-of-order where transmission processing of the PUSCH #A and transmission processing of the PUSCH #B are performed by reversing start-to-end orders of these transmission processing.

When, for example, performing the transmission processing of the PUSCH #A and the transmission processing of the PUSCH #B by reversing the start-to-end orders of these transmission processing (out-of-order), the UE may determine the transmission power of the given type PUSCH (e.g., PUSCH #A) by taking into account a TPC command for an another type PUSCH (e.g., PUSCH #B), too. On the other hand, when performing the transmission processing of the PUSCH #A and the transmission processing of the PUSCH #B in forward start-to-end orders of these transmission processing (in-order), the UE may determine the transmission power of the given type PUSCH #A without taking into account a TPC command for the another type PUSCH #B.

FIG. 8B illustrates one example of transmit power control (e.g., TPC command accumulation method) in a case where the first type PUSCH #A and the second type PUSCH #B are transmitted. In this regard, FIG. 8B illustrates a case where, after transmission processing of the PUSCH #A1 and transmission processing of the PUSCH #B1 are performed in forward start-to-end orders of these transmission processing (in-order), transmission processing of the PUSCH #A2 and transmission processing of the PUSCH #B2 are performed by reversing start-to-end orders of these transmission processing (out-of-order).

The UE determines transmission power for the PUSCH #A1 based on power control information (e.g., TPC command P (A1)) included in the PDCCH #A1. Furthermore, the UE determines transmission power for the PUSCH #B1 based on power control information (e.g., TPC command P (B1)) included in the PDCCH #B1.

In this case, the UE performs control to not accumulate the TPC command P (A1)) for another type as transmission power of the PUSCH #B1. In this regard, if there is the PUCCH #B that is transmitted earlier than the PUSCH #A1, out-of-order is not applied, and therefore the UE performs control to not accumulate the TPC command P (B1) for another type as transmission power of the PUSCH #A1.

In FIG. 8B, the transmission processing of the PUSCH #A2 and the transmission processing of the PUSCH #B2 are performed by reversing the start-to-end orders of these transmission processing (application of out-of-order). The UE determines transmission power for the PUSCH #B2 without taking into account a TPC command for another type even at a time of application of out-of-order. More specifically, the UE may determine transmission power for the PUSCH #B2 by taking into account accumulation of a TPC command P (B2) included in the PDCCH #B2 for scheduling the PUSCH #B2, and a TPC command (P (B1) in this case) for the same type that has already been obtained.

The UE determines transmission power for the PUSCH #A2 by taking into account a TPC command for another type, too, at a time of application of out-of-order. The UE may determine transmission power for the PUSCH #A2 by taking into account P (A1) and P (A2) and, in addition, a TPC command included in another type PDCCH (PDCCH #B2) that is transmitted earlier than the PUSCH #A2 during out-of-order processing. For example, the UE determines the transmission power of the PUSCH #B2 by accumulating the TPC commands P (A1), P (A2) and P (B2).

In addition, the above description has described the case where the UE takes into account a TPC command for another type when determining transmission power of a given type PUSCH at a time of application of out-of-order. However, the present disclosure is not limited to this. The UE may perform control to take into account a TPC command for another type when determining transmission power of a given type PUSCH at a time of application of in-order, and to not take into account a TPC command for another type to determine transmission power of a given type PUSCH at a time of application of out-of-order.

(Fourth Aspect)

According to the fourth aspect, transmission power is determined for each type UL channel transmission by taking into account a TPC command for another type, too. Hereinafter, a case where transmission power is controlled for first type UL channel transmission and second type UL channel transmission by taking into account each of a TPC command for a first type UL channel and a TPC command for a second type UL channel will be described. In addition, for example, classification of a UL channel type and a decision method may be controlled similar to the first aspect.

A UE may determine transmission power of a first type PUSCH #A by taking into account a TPC command #A (corresponding to, for example, a power control adjustment state #A) included in a PDCCH #A and, in addition, a TPC command #B (corresponding to, for example, a power control adjustment state #B) included in a PDCCH #B, too. In this regard, the PDCCH #A (or DCI #A) may be used to schedule the first type PUSCH #A, and the PDCCH #B (or DCI #B) may be used to schedule a second type PUSCH #B.

Similarly, the UE may determine transmission power of the second type PUSCH #B by taking into account the TPC command #B included in the PDCCH #B and, in addition, the TPC command #A included in the PDCCH #A.

That is, when transmission power of each type PUSCH #A and PUSCH #B is determined, accumulation of the TPC command #A and the TPC command #B is permitted. The UE may control based on given conditions whether or not to accumulate the TPC command #B in a case where transmission power of the PUSCH #A is determined or whether or not to accumulate the TPC command #A in a case where transmission power of the PUSCH #B is determined.

The given condition may be at least one of a PUSCH transmission timing, a PDCCH (or DCI) transmission timing, whether or not to apply out-of-order and a TPC configuration. Hereinafter, cases (cases 4-1 to 4-4) where whether or not to accumulate the TPC command #B when the transmission power of the PUSCH #A is determined and whether or not to accumulate the TPC command #A when the transmission power of the PUSCH #B is determined will be described.

<Case 4-1>

The UE may determine transmission power of a PUSCH by taking into account (e.g., accumulating) a TPC command included in a PDCCH (or DCI) whose transmission timing is earlier than that of the PUSCH whose transmission has been indicated.

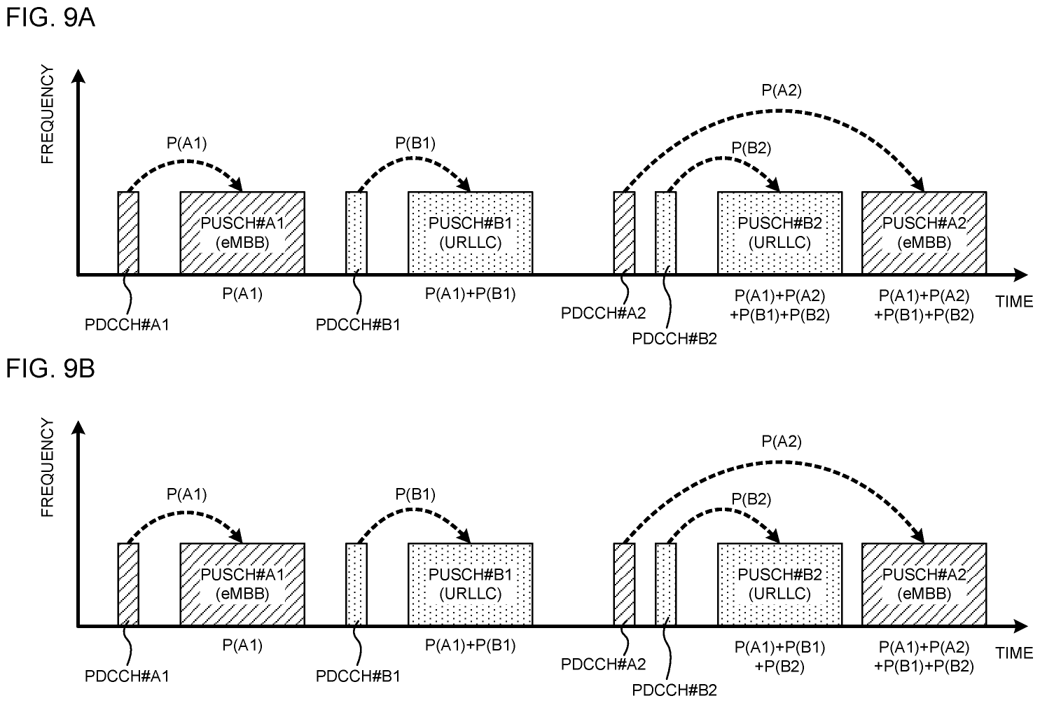

FIG. 9A illustrates one example of transmit power control (e.g., TPC command accumulation method) in a case where the first type PUSCH #A and the second type PUSCH #B are transmitted. In this regard, FIG. 9A illustrates a case where, after transmission processing of a PUSCH #A1 and transmission processing of a PUSCH #B1 are performed in forward start-to-end orders of these transmission processing (in-order), transmission processing of a PUSCH #A2 and transmission processing of a PUSCH #B2 are performed by reversing start-to-end orders of these transmission processing (out-of-order).

The UE determines transmission power for the PUSCH #A1 by taking into account a TPC command P (A1) included in a PDCCH #A1. Furthermore, the UE determines transmission power for the PUSCH #B1 by taking into account (e.g., accumulating) the TPC command P (A1) received before transmission of the PUSCH #B and the TPC command P (B1) included in a PDCCH #B1.

In FIG. 9A, a transmission timing of a PDCCH #A2 for scheduling the PUSCH #A2 is earlier than a transmission timing of the PUSCH #B2. The UE may determine transmission power for the PUSCH #B2 by taking into account TPC commands included in PDCCHs (PDCCHs #A1, #B1, #A2 and #B2) transmitted earlier than the PUSCH #B. For example, the UE determines the transmission power of the PUSCH #B2 by accumulating the TPC commands P (A1), P (B1), P (A2) and P (B2).

The UE may determine transmission power for the PUSCH #A2 by taking into account TPC commands included in PDCCHs (PDCCHs #A1, #B1, #A2 and #B2) transmitted earlier than the PUSCH #A2. For example, the UE determines the transmission power of the PUSCH #B2 by accumulating the TPC commands P (A1), P (B1), P (A2) and P (B2).

Thus, by determining transmission power by taking into account a plurality of TPC commands associated with PUSCH transmission of different types, it is possible to flexibly control transmission power according to a change of communication environment.

<Case 4-2>

The UE may determine transmission power of a given PUSCH by taking into account (e.g., accumulating) a TPC command included in a PDCCH (or DCI) for scheduling another PUSCH whose transmission timing is earlier than the given PUSCH whose transmission has been indicated. That is, case 4-2 adopts a condition that not only the transmission timing of the PDCCH but also the transmission timing of the another PUSCH scheduled by the PDCCH are earlier than that of given PUSCH in case 4-1.

FIG. 9B illustrates one example of transmit power control (e.g., TPC command accumulation method) in a case where the first type PUSCH #A and the second type PUSCH #B are transmitted. In this regard, FIG. 9B illustrates a case where, after transmission processing of the PUSCH #A1 and transmission processing of the PUSCH #B1 are performed in forward start-to-end orders of these transmission processing (in-order), transmission processing of the PUSCH #A2 and transmission processing of the PUSCH #B2 are performed by reversing start-to-end orders of these transmission processing (out-of-order).

The UE may perform transmit power control (e.g., accumulation of TPC commands) of the PUSCH #A1 and the PUSCH #B1 similar to case 4-1.

In FIG. 9B, a transmission timing of the PDCCH #A2 for scheduling the PUSCH #A2 is earlier than a transmission timing of the PUSCH #B2, yet a transmission timing of the PUSCH #A2 is later than a transmission timing of the PUSCH #B2. The UE may determine transmission power for the PUSCH #B2 by taking into account TPC commands included in the PDCCHs #B1 and #B2 and, in addition, a TPC command associated with an another type PUSCH (e.g. PUSCH #A1) whose transmission timing is earlier than that of the PUSCH #B2.

In this case, the UE may determine the transmission power of the PUSCH #B2 by accumulating the TPC commands P (A1), P (B1) and P (B2). On the other hand, the transmission timing of the PDCCH #A2 for scheduling the PUSCH #A2 is earlier than that of the PUSCH #B2, yet the transmission timing of the PUSCH #A2 is later than that of the PUSCH #B2, and therefore the transmission power of the PUSCH #B2 is determined without taking P (A2) into account.

In FIG. 9B, the transmission timing of the PDCCH #B2 for scheduling the PUSCH #B2 is earlier than the transmission timing of the PUSCH #A2. The UE may determine the transmission power for the PUSCH #A2 by taking into account TPC commands included in PDCCHs (PDCCHs #A1, #B1, #A2 and #B2) transmitted earlier than the PUSCH #A2. For example, the UE determines the transmission power of the PUSCH #A2 by accumulating the TPC commands P (A1), P (B1), P (A2) and P (B2).

Furthermore, by controlling whether or not to accumulate a TPC command based on a transmission timing of a PUSCH, it is possible to secure a duration of a PDCCH (e.g., the PDCCH #B2) including a TPC command that is taken into account to determine transmission power, and a PUSCH (e.g., PUSCH #A2) to some degree, so that it is possible to suppress a UE processing load.

<Case 4-3/4-4>

The UE may determine whether or not to accumulate a TPC command for an another type PUSCH when determining transmission power of given type PUSCH transmission based on whether or not to apply out-of-order where transmission processing of the PUSCH #A and transmission processing of the PUSCH #B are performed by reversing start-to-end orders of these transmission processing.

When, for example, performing the transmission processing of the PUSCH #A and the transmission processing of the PUSCH #B by reversing the start-to-end orders of these transmission processing (out-of-order), the UE may determine the transmission power of the given type PUSCH by taking into account a TPC command for an another type PUSCH, too. On the other hand, when performing the transmission processing of the PUSCH #A and the transmission processing of the PUSCH #B in forward start-to-end orders of these transmission processing (in-order), the UE may determine the transmission power of the given type PUSCH without taking into account a TPC command for the another type PUSCH.

Furthermore, when applying out-of-order, the UE may further determine for transmission power of a given type PUSCH whether or not to accumulate a TPC command for another type PUSCH, based on a given condition. The given condition may be a transmission timing of the given type PUSCH or a transmission timing of a PDCCH for scheduling an another type PUSCH (case 4-3). Alternatively, the given condition may be a transmission timing of the given type PUSCH or a transmission timing of an another type PUSCH (case 4-4).

In case 4-3, during out-of-order processing, the UE may determine the transmission power of the given type PUSCH by taking into account a TPC command included in a PDCCH (or DCI) whose transmission timing is earlier than that of the given type PUSCH whose transmission has been indicated.

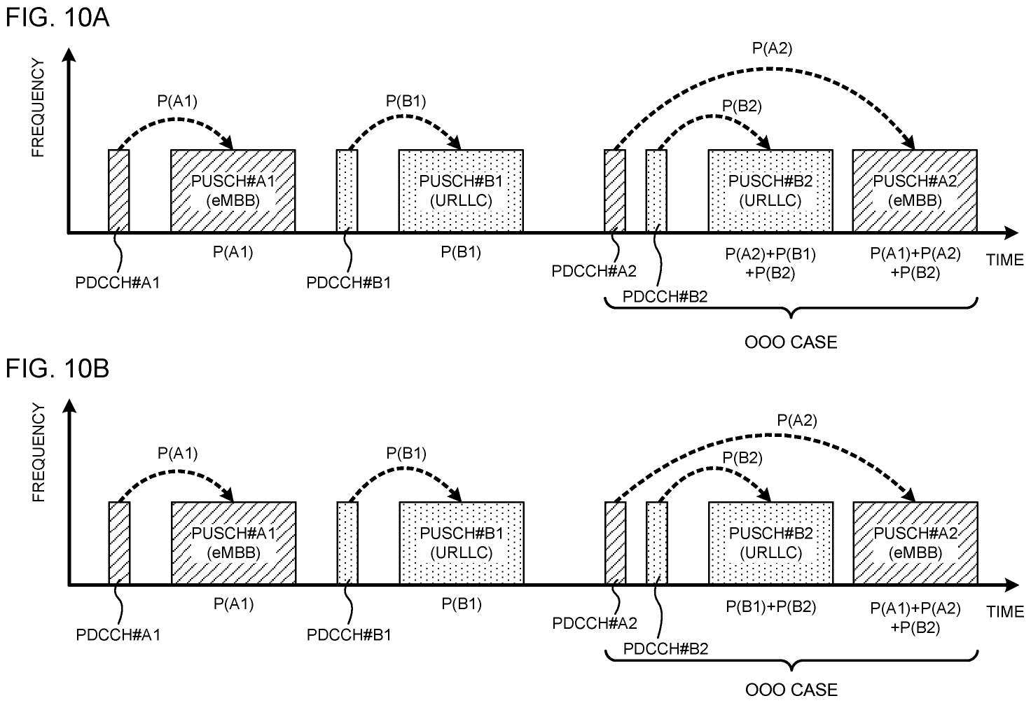

FIG. 10A illustrates one example of transmit power control (e.g., TPC command accumulation method) in a case where the first type PUSCH #A and the second type PUSCH #B are transmitted. In this regard, FIG. 10A illustrates a case where, after transmission processing of the PUSCH #A1 and transmission processing of the PUSCH #B1 are performed in forward start-to-end orders of these transmission processing (in-order), transmission processing of the PUSCH #A2 and transmission processing of the PUSCH #B2 are performed by reversing start-to-end orders of these transmission processing (out-of-order).

The UE determines transmission power for the PUSCH #A1 based on power control information (e.g., TPC command P (A1)) included in the PDCCH #A1. Furthermore, the UE determines transmission power for the PUSCH #B1 based on power control information (e.g., TPC command P (B1)) included in the PDCCH #B1. That is, the UE does not take into account the TPC command P (A1) for another type during transmit power control of the PUSCH #B1 at a time of in-order processing.

In FIG. 10A, the transmission processing of the PUSCH #A2 and the transmission processing of the PUSCH #B2 are performed by reversing the start-to-end orders of these transmission processing (application of out-of-order). Furthermore, a transmission timing of the PDCCH #A2 for scheduling the PUSCH #A2 is earlier than a transmission timing of the PUSCH #B2. The UE may determine transmission power for the PUSCH #B2 by taking into account P (B1) and P (B2) and, in addition, a TPC command included in an another type PDCCH (PDCCH #A2) that is transmitted earlier than the PUSCH #B2 during out-of-order processing. For example, the UE determines the transmission power of the PUSCH #B2 by accumulating the TPC commands P (B1), P (B2) and P (A2).

The UE may determine transmission power for the PUSCH #A2 by taking into account P (A1) and P (A2) and, in addition, a TPC command included in another type PDCCH (PDCCH #B2) that is transmitted earlier than the PUSCH #A2 during out-of-order processing. For example, the UE determines the transmission power of the PUSCH #B2 by accumulating the TPC commands P (A1), P (A2) and P (B2).

In case 4-4, during out-of-order processing, the UE may determine transmission power of a given type PUSCH by taking into account a TPC command included in a PDCCH (or DCI) for scheduling another type PUSCH whose transmission timing is earlier than that of the given type PUSCH whose transmission has been indicated.

In FIG. 10B, the UE may perform transmit power control (e.g., accumulation of TPC commands) of the PUSCH #A1 and the PUSCH #B1 similar to case 4-3.

In FIG. 10B, the transmission processing of the PUSCH #A2 and the transmission processing of the PUSCH #B2 are performed by reversing the start-to-end orders of these transmission processing (application of out-of-order). Furthermore, a transmission timing of the PDCCH #A2 for scheduling the PUSCH #A2 is earlier than a transmission timing of the PUSCH #B2, yet a transmission timing of the PUSCH #A2 is later than a transmission timing of the PUSCH #B2. The UE may determine transmission power for the PUSCH #B2 by taking into account TPC commands included in the PDCCHs #B1 and #B2 (without taking into account a TPC command included in the PUSCH #A2).

In this regard, the UE may determine the transmission power of the PUSCH #B2 by accumulating the TPC commands P (B1) and P (B2). On the other hand, the transmission timing of the PDCCH #A2 for scheduling the PUSCH #A2 is earlier than that of the PUSCH #B2, yet the transmission timing of the PUSCH #A2 is later than that of the PUSCH #B2, and therefore the transmission power of the PUSCH #B2 is determined without taking P (A2) into account.

In FIG. 10B, the transmission timing of the PDCCH #B2 for scheduling the PUSCH #B2 is earlier than the transmission timing of the PUSCH #A2. The UE may determine transmission power for the PUSCH #A2 by taking into account a TPC command included in the another type PDCCH #B2 that is transmitted earlier than the PUSCH #A2 during out-of-order processing. For example, the UE determines the transmission power of the PUSCH #A2 by accumulating the TPC commands P (A1), P (A2) and P (B2).

In addition, the above description has described the case where the UE takes into account a TPC command for another type when determining transmission power of a given type PUSCH at a time of application of out-of-order. However, the present disclosure is not limited to this. The UE may perform control to take into account a TPC command for another type when determining transmission power of a given type PUSCH at a time of application of in-order, and to not take into account a TPC command for another type to determine transmission power of a given type PUSCH at a time of application of out-of-order.

(Fifth Aspect)

A UE may switch and apply transmit power control described in the above first aspect to the fourth aspect. For example, the UE may select first transmit power control (see, for example, FIG. 5) described in the first aspect, second transmit power control described in one of case 2-1 to case 2-3 (see, for example, FIGS. 6 and 7) and the variation of the second aspect, third transmit power control described in one of cases 3-1 and 3-2 (see, for example, FIG. 8) of the third aspect, and fourth transmit power control described in one of cases 4-1 to 4-4 (see, for example, FIGS. 9 and 10) of the fourth aspect.

In one example, the UE may determine transmit power control (at least one of the first transmit power control to the fourth transmit power control) to be applied, based on information notified from a network (e.g., base station). The base station may give a notification to the UE by using a higher layer signaling (e.g., given higher layer parameter). Furthermore, the same transmit power control may be configured per PUSCH transmission type (or PUCCH transmission type), or different transmit power control may be configured.

Alternatively, the UE may determine transmit power control (at least one of the first transmit power control to the fourth transmit power control) to be applied, based on at least one of DCI notified from the base station, an RNTI to be applied, and given information (e.g., MCS) notified by the DCI.

The UE may determine transmit power control to be applied, based on an RNTI type to be applied to CRC scrambling. When, for example, a PDCCH (or DCI) CRC-scrambled by a C-RNTI schedules data (e.g., shared channel), the UE may apply given transmit power control (e.g., second transmit power control (e.g., case 2-1)). On the other hand, when a PDCCH (or DCI) CRC-scrambled by a CS-RNTI schedules data (e.g., shared channel), the UE may apply another transmit power control (e.g., fourth transmit power control (e.g., case 4-1)).

Alternatively, the UE may determine transmit power control to be applied, based on an MCS table type to be applied to scheduling (transmission or reception) of data. When, for example, data (e.g., shared channel) is scheduled based on a new 64 QAM MCS table, the UE may apply the second transmit power control (e.g., case 2-1). On the other hand, when, for example, data (e.g., shared channel) is scheduled based on an MCS table other than the new 64 QAM MCS table, the UE may apply the fourth transmit power control (e.g., case 4-1).

Alternatively, the UE may determine transmit power control to be applied, according to configured grant-based PUSCH transmission or dynamic grant-based PUSCH transmission. For example, the UE may apply the second transmit power control (e.g., case 2-1) in a case where a configured grant-based parameter (e.g., configuredGrantConfig) is configured, and apply the fourth transmit power control (e.g., case 4-1) in a case where the configured grant-based parameter is not configured.

(Radio Communication System)

The configuration of the radio communication system according to one embodiment of the present disclosure will be described below. This radio communication system uses one or a combination of the radio communication method according to each of the above embodiment of the present disclosure to perform communication.

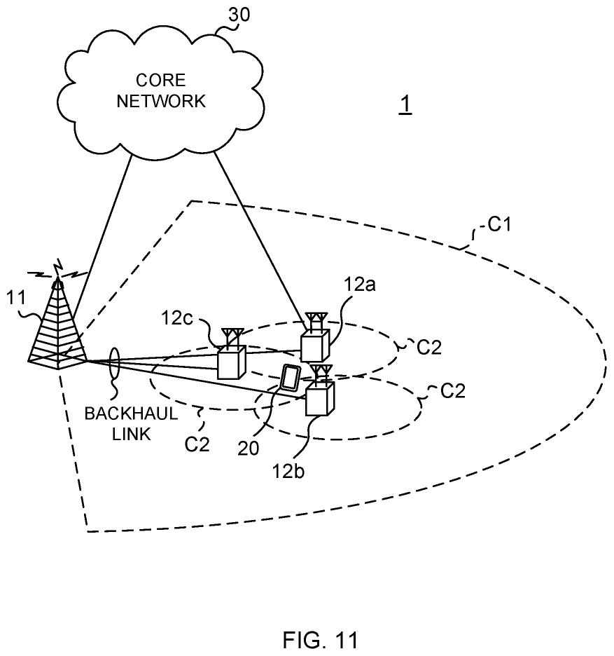

FIG. 11 is a diagram illustrating one example of a schematic configuration of the radio communication system according to the one embodiment. A radio communication system 1 may be a system that realizes communication by using Long Term Evolution (LTE) or the 5th generation mobile communication system New Radio (5G NR) specified by the Third Generation Partnership Project (3GPP).

Furthermore, the radio communication system 1 may support dual connectivity between a plurality of Radio Access Technologies (RATs) (Multi-RAT Dual Connectivity (MR-DC)). MR-DC may include dual connectivity (E-UTRA-NR Dual Connectivity (EN-DC)) of LTE (Evolved Universal Terrestrial Radio Access (E-UTRA)) and NR, and dual connectivity (NR-E-UTRA Dual Connectivity (NE-DC)) of NR and LTE.

According to EN-DC, a base station (eNB) of LTE (E-UTRA) is a Master Node (MN), and a base station (gNB) of NR is a Secondary Node (SN). According to NE-DC, a base station (gNB) of NR is an MN, and a base station (eNB) of LTE (E-UTRA) is an SN.

The radio communication system 1 may support dual connectivity between a plurality of base stations in an identical RAT (e.g., dual connectivity (NR-NR Dual Connectivity (NN-DC)) where both of the MN and the SN are base stations (gNBs) according to NR).

The radio communication system 1 may include a base station 11 that forms a macro cell C1 of a relatively wide coverage, and base stations 12 (12a to 12c) that are located in the macro cell C1 and form small cells C2 narrower than the macro cell C1. The user terminal 20 may be located in at least one cell. An arrangement and the numbers of respective cells and the user terminals 20 are not limited to the aspect illustrated in FIG. 11. The base stations 11 and 12 will be collectively referred to as a base station 10 below when not distinguished.

The user terminal 20 may connect with at least one of a plurality of base stations 10. The user terminal 20 may use at least one of Carrier Aggregation (CA) and Dual Connectivity (DC) that use a plurality of Component Carriers (CCs).

Each CC may be included in at least one of a first frequency range (Frequency Range 1 (FR 1)) and a second frequency range (Frequency Range 2 (FR 2)). The macro cell C1 may be included in the FR 1, and the small cell C2 may be included in the FR 2. For example, the FR 1 may be a frequency range equal to or less than 6 GHz (sub-6 GHz), and the FR 2 may be a frequency range higher than 24 GHz (above-24 GHz). In addition, the frequency ranges and definitions of the FR 1 and the FR 2 are not limited to these, and, for example, the FR 1 may correspond to a frequency range higher than the FR 2.

Furthermore, the user terminal 20 may perform communication by using at least one of Time Division Duplex (TDD) and Frequency Division Duplex (FDD) in each CC.

A plurality of base stations 10 may be connected by way of wired connection (e.g., optical fibers compliant with a Common Public Radio Interface (CPRI) or an X2 interface) or radio connection (e.g., NR communication). When, for example, NR communication is used as a backhaul between the base stations 11 and 12, the base station 11 corresponding to a higher station may be referred to as an Integrated Access Backhaul (IAB) donor, and the base station 12 corresponding to a relay station (relay) may be referred to as an IAB node.

The base station 10 may be connected with a core network 30 via the another base station 10 or directly. The core network 30 may include at least one of, for example, an Evolved Packet Core (EPC), a 5G Core Network (SGCN) and a Next Generation Core (NGC).

The user terminal 20 is a terminal that supports at least one of communication schemes such as LTE, LTE-A and 5G.

The radio communication system 1 may use an Orthogonal Frequency Division Multiplexing (OFDM)-based radio access scheme. For example, on at least one of Downlink (DL) and Uplink (UL), Cyclic Prefix OFDM (CP-OFDM), Discrete Fourier Transform Spread OFDM (DFT-s-OFDM), Orthogonal Frequency Division Multiple Access (OFDMA) and Single Carrier Frequency Division Multiple Access (SC-FDMA) may be used.

The radio access scheme may be referred to as a waveform. In addition, the radio communication system 1 may use another radio access scheme (e.g., another single carrier transmission scheme or another multicarrier transmission scheme) as the radio access scheme on UL and DL.

The radio communication system 1 may use a downlink shared channel (Physical Downlink Shared Channel (PDSCH)) shared by each user terminal 20, a broadcast channel (Physical Broadcast Channel (PBCH)) and a downlink control channel (Physical Downlink Control Channel (PDCCH)) as downlink channels.

Furthermore, the radio communication system 1 may use an uplink shared channel (Physical Uplink Shared Channel (PUSCH)) shared by each user terminal 20, an uplink control channel (Physical Uplink Control Channel (PUCCH)) and a random access channel (Physical Random Access Channel (PRACH)) as uplink channels.

User data, higher layer control information and a System Information Block (SIB) are conveyed on the PDSCH. The user data and the higher layer control information may be conveyed on the PUSCH. Furthermore, a Master Information Block (MIB) may be conveyed on the PBCH.

Lower layer control information may be conveyed on the PDCCH. The lower layer control information may include, for example, Downlink Control Information (DCI) including scheduling information of at least one of the PDSCH and the PUSCH.

In addition, DCI for scheduling the PDSCH may be referred to as, for example, a DL assignment or DL DCI, and DCI for scheduling the PUSCH may be referred to as, for example, a UL grant or UL DCI. In this regard, the PDSCH may be read as DL data, and the PUSCH may be read as UL data.

A COntrol REsource SET (CORESET) and a search space may be used to detect the PDCCH. The CORESET corresponds to a resource for searching DCI. The search space corresponds to a search domain and a search method of PDCCH candidates. One CORESET may be associated with one or a plurality of search spaces. The UE may monitor a CORESET associated with a given search space based on a search space configuration.

One search space may be associated with a PDCCH candidate corresponding to one or a plurality of aggregation levels. One or a plurality of search spaces may be referred to as a search space set. In addition, a “search space”, a “search space set”, a “search space configuration”, a “search space set configuration”, a “CORESET” and a “CORESET configuration” in the present disclosure may be interchangeably read.

Uplink Control Information (UCI) including at least one of Channel State Information (CSI), transmission acknowledgement information (that may be referred to as, for example, Hybrid Automatic Repeat reQuest ACKnowledgement (HARQ-ACK) or ACK/NACK) and a Scheduling Request (SR) may be conveyed on the PUCCH. A random access preamble for establishing connection with a cell may be conveyed on the PRACH.

In addition, downlink and uplink in the present disclosure may be expressed without adding “link” thereto. Furthermore, various channels may be expressed without adding “physical” to heads of the various channels.

The radio communication system 1 may convey a Synchronization Signal (SS) and a Downlink Reference Signal (DL-RS). The radio communication system 1 may convey a Cell-specific Reference Signal (CRS), a Channel State Information Reference Signal (CSI-RS), a DeModulation Reference Signal (DMRS), a Positioning Reference Signal (PRS) and a Phase Tracking Reference Signal (PTRS) as DL-RSs.

The synchronization signal may be at least one of, for example, a Primary Synchronization Signal (PSS) and a Secondary Synchronization Signal (SSS). A signal block including the SS (the PSS or the SSS) and the PBCH (and the DMRS for the PBCH) may be referred to as, for example, an SS/PBCH block or an SS Block (SSB). In addition, the SS and the SSB may be also referred to as reference signals.

Furthermore, the radio communication system 1 may convey a Sounding Reference Signal (SRS) and a DeModulation Reference Signal (DMRS) as UpLink Reference Signals (UL-RSs). In this regard, the DMRS may be referred to as a user terminal-specific reference signal (UE-specific reference signal).

(Base Station)

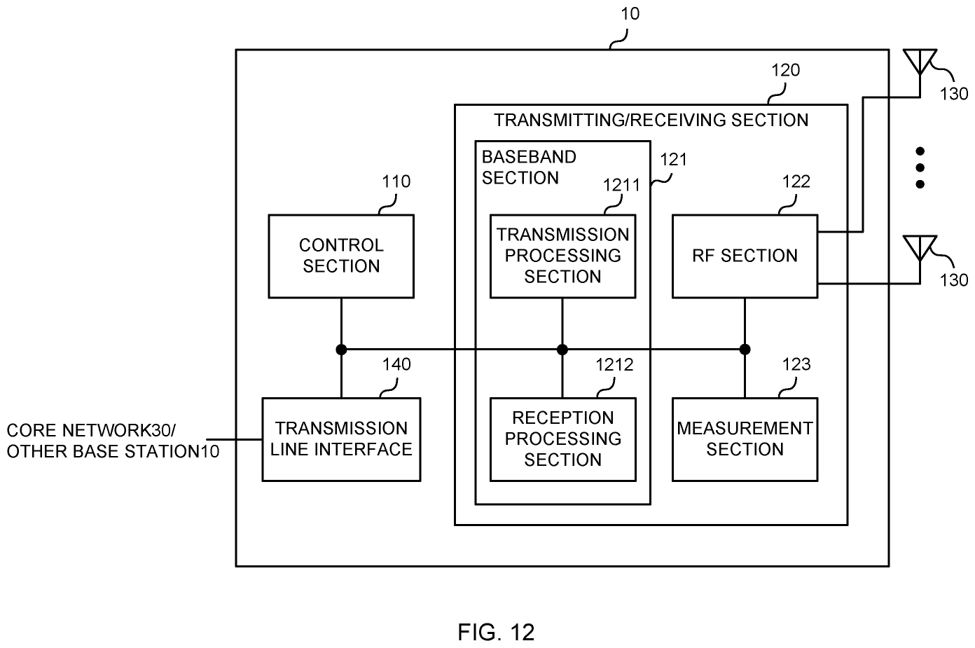

FIG. 12 is a diagram illustrating one example of a configuration of the base station according to the one embodiment. The base station 10 includes a control section 110, a transmitting/receiving section 120, transmission/reception antennas 130 and a transmission line interface 140. In addition, the base station 10 may include one or more of each of the control sections 110, the transmitting/receiving sections 120, the transmission/reception antennas 130 and the transmission line interfaces 140.

In addition, this example mainly illustrates function blocks of characteristic portions according to the present embodiment, and may assume that the base station 10 includes other function blocks, too, that are necessary for radio communication. Part of processing of each section described below may be omitted.

The control section 110 controls the entire base station 10. The control section 110 can be composed of a controller or a control circuit described based on the common knowledge in the technical field according to the present disclosure.

The control section 110 may control signal generation and scheduling (e.g., resource allocation or mapping). The control section 110 may control transmission/reception and measurement that use the transmitting/receiving section 120, the transmission/reception antennas 130 and the transmission line interface 140. The control section 110 may generate data, control information or a sequence to be transmitted as a signal, and forward the signal to the transmitting/receiving section 120. The control section 110 may perform call processing (such as configuration and release) of a communication channel, state management of the base station 10 and radio resource management.

The transmitting/receiving section 120 may include a baseband section 121, a Radio Frequency (RF) section 122 and a measurement section 123. The baseband section 121 may include a transmission processing section 1211 and a reception processing section 1212. The transmitting/receiving section 120 can be composed of a transmitter/receiver, an RF circuit, a baseband circuit, a filter, a phase shifter, a measurement circuit and a transmission/reception circuit described based on the common knowledge in the technical field according to the present disclosure.

The transmitting/receiving section 120 may be composed as an integrated transmitting/receiving section, or may be composed of a transmitting section and a receiving section. The transmitting section may be composed of the transmission processing section 1211 and the RF section 122. The receiving section may be composed of the reception processing section 1212, the RF section 122 and the measurement section 123.

The transmission/reception antenna 130 can be composed of an antenna such as an array antenna described based on the common knowledge in the technical field according to the present disclosure.

The transmitting/receiving section 120 may transmit the above-described downlink channel, synchronization signal and downlink reference signal. The transmitting/receiving section 120 may receive the above-described uplink channel and uplink reference signal.

The transmitting/receiving section 120 may form at least one of a transmission beam and a reception beam by using digital beam forming (e.g., precoding) or analog beam forming (e.g., phase rotation).

The transmitting/receiving section 120 (transmission processing section 1211) may perform Packet Data Convergence Protocol (PDCP) layer processing, Radio Link Control (RLC) layer processing (e.g., RLC retransmission control), and Medium Access Control (MAC) layer processing (e.g., HARQ retransmission control) on, for example, the data and the control information obtained from the control section 110, and generate a bit sequence to transmit.

The transmitting/receiving section 120 (transmission processing section 1211) may perform transmission processing such as channel coding (that may include error correction coding), modulation, mapping, filter processing, Discrete Fourier Transform (DFT) processing (when needed), Inverse Fast Fourier Transform (IFFT) processing, precoding and digital-analog conversion on the bit sequence to transmit, and output a baseband signal.

The transmitting/receiving section 120 (RF section 122) may modulate the baseband signal into a radio frequency range, perform filter processing and amplification on the signal, and transmit the signal of the radio frequency range via the transmission/reception antennas 130.

On the other hand, the transmitting/receiving section 120 (RF section 122) may perform amplification and filter processing on the signal of the radio frequency range received by the transmission/reception antennas 130, and demodulate the signal into a baseband signal.

The transmitting/receiving section 120 (reception processing section 1212) may apply reception processing such as analog-digital conversion, Fast Fourier Transform (FFT) processing, Inverse Discrete Fourier Transform (IDFT) processing (when needed), filter processing, demapping, demodulation, decoding (that may include error correction decoding), MAC layer processing, RLC layer processing and PDCP layer processing to the obtained baseband signal, and obtain user data.

The transmitting/receiving section 120 (measurement section 123) may perform measurement related to the received signal. For example, the measurement section 123 may perform Radio Resource Management (RRM) measurement or Channel State Information (CSI) measurement based on the received signal. The measurement section 123 may measure received power (e.g., Reference Signal Received Power (RSRP)), received quality (e.g., Reference Signal Received Quality (RSRQ), a Signal to Interference plus Noise Ratio (SINR) or a Signal to Noise Ratio (SNR)), a signal strength (e.g., a Received Signal Strength Indicator (RSSI)) or channel information (e.g., CSI). The measurement section 123 may output a measurement result to the control section 110.

The transmission line interface 140 may transmit and receive (backhaul signaling) signals to and from apparatuses and the other base stations 10 included in the core network 30, and obtain and convey user data (user plane data) and control plane data for the user terminal 20.

In addition, the transmitting section and the receiving section of the base station 10 according to the present disclosure may be composed of at least one of the transmitting/receiving section 120, the transmission/reception antenna 130 and the transmission line interface 140.

In addition, the transmitting/receiving section 120 transmits first downlink control information that includes a first transmit power control command for a first type uplink channel, and second downlink control information that includes a second transmit power control command for a second type uplink channel.

When a transmission timing of the second downlink control information is later than that of the first downlink control information, and a transmission timing of the first type uplink channel is later than that of the second type uplink channel, the control section 110 may control notification of a TPC command so as to control accumulation of the first transmit power control command and the second transmit power control command based on at least one of an uplink channel type, a power control adjustment state index, a downlink control information transmission timing and an uplink channel transmission timing.

(User Terminal)

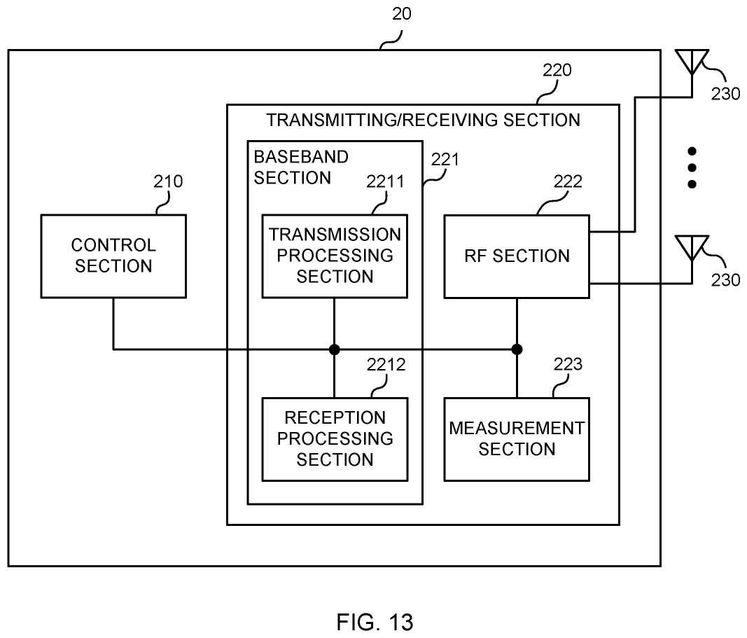

FIG. 13 is a diagram illustrating one example of a configuration of the user terminal according to the one embodiment. The user terminal 20 includes a control section 210, a transmitting/receiving section 220 and transmission/reception antennas 230. In this regard, the user terminal 20 may include one or more of each of the control sections 210, the transmitting/receiving sections 220 and the transmission/reception antennas 230.

In addition, this example mainly illustrates function blocks of characteristic portions according to the present embodiment, and may assume that the user terminal 20 includes other function blocks, too, that are necessary for radio communication. Part of processing of each section described below may be omitted.

The control section 210 controls the entire user terminal 20. The control section 210 can be composed of a controller or a control circuit described based on the common knowledge in the technical field according to the present disclosure.

The control section 210 may control signal generation and mapping. The control section 210 may control transmission/reception and measurement that use the transmitting/receiving section 220 and the transmission/reception antennas 230. The control section 210 may generate data, control information or a sequence to be transmitted as a signal, and forward the signal to the transmitting/receiving section 220.

The transmitting/receiving section 220 may include a baseband section 221, an RF section 222 and a measurement section 223. The baseband section 221 may include a transmission processing section 2211 and a reception processing section 2212. The transmitting/receiving section 220 can be composed of a transmitter/receiver, an RF circuit, a baseband circuit, a filter, a phase shifter, a measurement circuit and a transmission/reception circuit described based on the common knowledge in the technical field according to the present disclosure.

The transmitting/receiving section 220 may be composed as an integrated transmitting/receiving section, or may be composed of a transmitting section and a receiving section. The transmitting section may be composed of the transmission processing section 2211 and the RF section 222. The receiving section may be composed of the reception processing section 2212, the RF section 222 and the measurement section 223.

The transmission/reception antenna 230 can be composed of an antenna such as an array antenna described based on the common knowledge in the technical field according to the present disclosure.

The transmitting/receiving section 220 may receive the above-described downlink channel, synchronization signal and downlink reference signal. The transmitting/receiving section 220 may transmit the above-described uplink channel and uplink reference signal.

The transmitting/receiving section 220 may form at least one of a transmission beam and a reception beam by using digital beam forming (e.g., precoding) or analog beam forming (e.g., phase rotation).

The transmitting/receiving section 220 (transmission processing section 2211) may perform PDCP layer processing, RLC layer processing (e.g., RLC retransmission control) and MAC layer processing (e.g., HARQ retransmission control) on, for example, the data and the control information obtained from the control section 210, and generate a bit sequence to transmit.

The transmitting/receiving section 220 (transmission processing section 2211) may perform transmission processing such as channel coding (that may include error correction coding), modulation, mapping, filter processing, DFT processing (when needed), IFFT processing, precoding and digital-analog conversion on the bit sequence to transmit, and output a baseband signal.

In this regard, whether or not to apply the DFT processing may be based on a configuration of transform precoding. When transform precoding is enabled for a given channel (e.g., PUSCH), the transmitting/receiving section 220 (transmission processing section 2211) may perform the DFT processing as the above transmission processing to transmit the given channel by using a DFT-s-OFDM waveform. When precoding is not enabled, the transmitting/receiving section 220 (transmission processing section 2211) may not perform the DFT processing as the above transmission processing.

The transmitting/receiving section 220 (RF section 222) may modulate the baseband signal into a radio frequency range, perform filter processing and amplification on the signal, and transmit the signal of the radio frequency range via the transmission/reception antennas 230.

On the other hand, the transmitting/receiving section 220 (RF section 222) may perform amplification and filter processing on the signal of the radio frequency range received by the transmission/reception antennas 230, and demodulate the signal into a baseband signal.

The transmitting/receiving section 220 (reception processing section 2212) may apply reception processing such as analog-digital conversion, FFT processing, IDFT processing (when needed), filter processing, demapping, demodulation, decoding (that may include error correction decoding), MAC layer processing, RLC layer processing and PDCP layer processing to the obtained baseband signal, and obtain user data.

The transmitting/receiving section 220 (measurement section 223) may perform measurement related to the received signal. For example, the measurement section 223 may perform, for example, RRM measurement or CSI measurement based on the received signal. The measurement section 223 may measure, for example, received power (e.g., RSRP), received quality (e.g., RSRQ, an SINR or an SNR), a signal strength (e.g., RSSI) or channel information (e.g., CSI). The measurement section 223 may output a measurement result to the control section 210.

In addition, the transmitting section and the receiving section of the user terminal 20 according to the present disclosure may be composed of at least one of the transmitting/receiving section 220 and the transmission/reception antenna 230.

In addition, the transmitting/receiving section 220 receives the first downlink control information that includes the first transmit power control command for the first type uplink channel, and the second downlink control information that includes the second transmit power control command for the second type uplink channel.

When the transmission timing of the second downlink control information is later than that of the first downlink control information, and the transmission timing of the first type uplink channel is later than that of the second type uplink channel, the control section 210 may control accumulation of the first transmit power control command and the second transmit power control command based on at least one of the uplink channel type, the power control adjustment state index, the downlink control information transmission timing and the uplink channel transmission timing.

The control section 210 may perform control to separately accumulate the first transmit power control command and the second transmit power control command respectively. Alternatively, the control section 210 may determine transmission power for the first type uplink channel based on accumulation of the first transmit power control command, and determine transmission power for the second type uplink channel based on accumulation of the first transmit power control command and the second transmit power control command.

Alternatively, the control section 210 may determine transmission power for the first type uplink channel and the second type uplink channel based on accumulation of the first transmit power control command and the second transmit power control command.

The control section 210 may control accumulation of the first transmit power control command and the second transmit power control command in a case where the transmission timing of the second downlink control information is later than the first downlink control information, and the transmission timing of the second type uplink channel is later than the first type uplink channel, and accumulation of the first transmit power control command and the second transmit power control command in a case where the transmission timing of the second downlink control information is later than the first downlink control information, and the transmission timing of the first type uplink channel is later than the second type uplink channel by different methods.

(Hardware Configuration)

In addition, the block diagrams used to describe the above embodiment illustrate blocks in function units. These function blocks (components) are realized by an arbitrary combination of at least ones of hardware components and software components. Furthermore, a method for realizing each function block is not limited in particular. That is, each function block may be realized by using one physically or logically coupled apparatus or may be realized by connecting two or more physically or logically separate apparatuses directly or indirectly (by using, for example, wired connection or radio connection) and using a plurality of these apparatuses. Each function block may be realized by combining software with the above one apparatus or a plurality of above apparatuses.

In this regard, the functions include deciding, determining, judging, calculating, computing, processing, deriving, investigating, looking up, ascertaining, receiving, transmitting, outputting, accessing, resolving, selecting, choosing, establishing, comparing, assuming, expecting, considering, broadcasting, notifying, communicating, forwarding, configuring, reconfiguring, allocating, mapping, and assigning, yet are not limited to these. For example, a function block (component) that causes transmission to function may be referred to as, for example, a transmitting unit or a transmitter. As described above, the method for realizing each function block is not limited in particular.

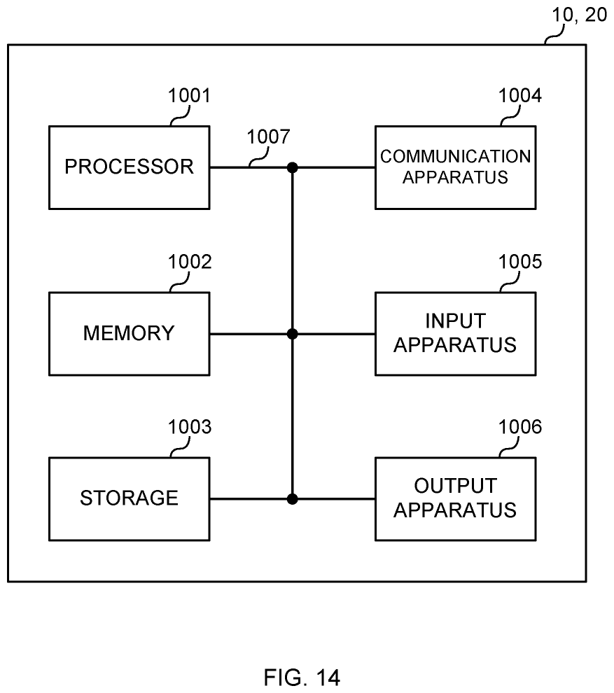

For example, the base station and the user terminal according to the one embodiment of the present disclosure may function as computers that perform processing of the radio communication method according to the present disclosure. FIG. 14 is a diagram illustrating one example of the hardware configurations of the base station and the user terminal according to the one embodiment. The above-described base station 10 and user terminal 20 may be each physically configured as a computer apparatus that includes a processor 1001, a memory 1002, a storage 1003, a communication apparatus 1004, an input apparatus 1005, an output apparatus 1006 and a bus 1007.

In this regard, words such as an apparatus, a circuit, a device, a section and a unit in the present disclosure can be interchangeably read. The hardware configurations of the base station 10 and the user terminal 20 may be configured to include one or a plurality of apparatuses illustrated in FIG. 14 or may be configured without including part of the apparatuses.

For example, FIG. 14 illustrates the only one processor 1001. However, there may be a plurality of processors. Furthermore, processing may be executed by 1 processor or processing may be executed by 2 or more processors simultaneously or successively or by using another method. In addition, the processor 1001 may be implemented by 1 or more chips.

Each function of the base station 10 and the user terminal 20 is realized by, for example, causing hardware such as the processor 1001 and the memory 1002 to read given software (program), and thereby causing the processor 1001 to perform an operation, and control communication via the communication apparatus 1004 and control at least one of reading and writing of data in the memory 1002 and the storage 1003.

The processor 1001 causes, for example, an operating system to operate to control the entire computer. The processor 1001 may be composed of a Central Processing Unit (CPU) including an interface for a peripheral apparatus, a control apparatus, an operation apparatus and a register. For example, at least part of the above-described control section 110 (210) and transmitting/receiving section 120 (220) may be realized by the processor 1001.

Furthermore, the processor 1001 reads programs (program codes), software modules or data from at least one of the storage 1003 and the communication apparatus 1004 out to the memory 1002, and executes various types of processing according to these programs, software modules or data. As the programs, programs that cause the computer to execute at least part of the operations described in the above-described embodiment are used. For example, the control section 110 (210) may be realized by a control program that is stored in the memory 1002 and operates on the processor 1001, and other function blocks may be also realized likewise.

The memory 1002 is a computer-readable recording medium, and may be composed of at least one of, for example, a Read Only Memory (ROM), an Erasable Programmable ROM (EPROM), an Electrically EPROM (EEPROM), a Random Access Memory (RAM) and other appropriate storage media. The memory 1002 may be referred to as, for example, a register, a cache or a main memory (main storage apparatus). The memory 1002 can store programs (program codes) and software modules that can be executed to perform the radio communication method according to the one embodiment of the present disclosure.

The storage 1003 is a computer-readable recording medium, and may be composed of at least one of, for example, a flexible disk, a floppy (registered trademark) disk, a magnetooptical disk (e.g., a compact disk (Compact Disc ROM (CD-ROM)), a digital versatile disk and a Blu-ray (registered trademark) disk), a removable disk, a hard disk drive, a smart card, a flash memory device (e.g., a card, a stick or a key drive), a magnetic stripe, a database, a server and other appropriate storage media. The storage 1003 may be referred to as an auxiliary storage apparatus.

The communication apparatus 1004 is hardware (transmission/reception device) that performs communication between computers via at least one of a wired network and a radio network, and is also referred to as, for example, a network device, a network controller, a network card and a communication module. The communication apparatus 1004 may be configured to include a high frequency switch, a duplexer, a filter and a frequency synthesizer to realize at least one of, for example, Frequency Division Duplex (FDD) and Time Division Duplex (TDD). For example, the above-described transmitting/receiving section 120 (220) and transmission/reception antennas 130 (230) may be realized by the communication apparatus 1004. The transmitting/receiving section 120 (220) may be physically or logically separately implemented as a transmitting section 120a (220a) and a receiving section 120b (220b).

The input apparatus 1005 is an input device (e.g., a keyboard, a mouse, a microphone, a switch, a button or a sensor) that accepts an input from an outside. The output apparatus 1006 is an output device (e.g., a display, a speaker or a Light Emitting Diode (LED) lamp) that sends an output to the outside. In addition, the input apparatus 1005 and the output apparatus 1006 may be an integrated component (e.g., touch panel).

Furthermore, each apparatus such as the processor 1001 or the memory 1002 is connected by the bus 1007 that communicates information. The bus 1007 may be composed by using a single bus or may be composed by using different buses between apparatuses.

Furthermore, the base station 10 and the user terminal 20 may be configured to include hardware such as a microprocessor, a Digital Signal Processor (DSP), an Application Specific Integrated Circuit (ASIC), a Programmable Logic Device (PLD) and a Field Programmable Gate Array (FPGA). The hardware may be used to realize part or entirety of each function block. For example, the processor 1001 may be implemented by using at least one of these hardware components.

### Modified Example

In addition, each term that has been described in the present disclosure and each term that is necessary to understand the present disclosure may be replaced with terms having identical or similar meanings. For example, a channel, a symbol and a signal (a signal or a signaling) may be interchangeably read. Furthermore, a signal may be a message. A reference signal can be also abbreviated as an RS, or may be referred to as a pilot or a pilot signal depending on standards to be applied. Furthermore, a Component Carrier (CC) may be referred to as, for example, a cell, a frequency carrier and a carrier frequency.

A radio frame may include one or a plurality of durations (frames) in a time domain. Each of one or a plurality of durations (frames) that makes up a radio frame may be referred to as a subframe. Furthermore, the subframe may include one or a plurality of slots in the time domain. The subframe may be a fixed time duration (e.g., 1 ms) that does not depend on a numerology.

In this regard, the numerology may be a communication parameter to be applied to at least one of transmission and reception of a given signal or channel. The numerology may indicate at least one of, for example, a SubCarrier Spacing (SCS), a bandwidth, a symbol length, a cyclic prefix length, a Transmission Time Interval (TTI), the number of symbols per TTI, a radio frame configuration, specific filtering processing performed by a transceiver in a frequency domain, and specific windowing processing performed by the transceiver in a time domain.

The slot may include one or a plurality of symbols (Orthogonal Frequency Division Multiplexing (OFDM) symbols or Single Carrier Frequency Division Multiple Access (SC-FDMA) symbols) in the time domain. Furthermore, the slot may be a time unit based on the numerology.

The slot may include a plurality of mini slots. Each mini slot may include one or a plurality of symbols in the time domain. Furthermore, the mini slot may be referred to as a subslot. The mini slot may include a smaller number of symbols than that of the slot. The PDSCH (or the PUSCH) to be transmitted in larger time units than that of the mini slot may be referred to as a PDSCH (PUSCH) mapping type A. The PDSCH (or the PUSCH) to be transmitted by using the mini slot may be referred to as a PDSCH (PUSCH) mapping type B.

The radio frame, the subframe, the slot, the mini slot and the symbol each indicate a time unit for conveying signals. The other corresponding names may be used for the radio frame, the subframe, the slot, the mini slot and the symbol. In addition, time units such as a frame, a subframe, a slot, a mini slot and a symbol in the present disclosure may be interchangeably read.

For example, 1 subframe may be referred to as a TTI, a plurality of contiguous subframes may be referred to as TTIs, or 1 slot or 1 mini slot may be referred to as a TTI. That is, at least one of the subframe and the TTI may be a subframe (1 ms) according to legacy LTE, may be a duration (e.g., 1 to 13 symbols) shorter than 1 ms or may be a duration longer than 1 ms. In addition, a unit that indicates the TTI may be referred to as, for example, a slot or a mini slot instead of a subframe.

In this regard, the TTI refers to, for example, a minimum time unit of scheduling of radio communication. For example, in the LTE system, the base station performs scheduling for allocating radio resources (a frequency bandwidth or transmission power that can be used in each user terminal) in TTI units to each user terminal. In this regard, a definition of the TTI is not limited to this.

The TTI may be a transmission time unit of a channel-coded data packet (transport block), code block or code word, or may be a processing unit of scheduling or link adaptation. In addition, when the TTI is given, a time period (e.g., the number of symbols) in which a transport block, a code block or a code word is actually mapped may be shorter than the TTI.

In addition, in a case where 1 slot or 1 mini slot is referred to as a TTI, 1 or more TTIs (i.e., 1 or more slots or 1 or more mini slots) may be a minimum time unit of scheduling. Furthermore, the number of slots (the number of mini slots) that make up a minimum time unit of the scheduling may be controlled.

The TTI having the time duration of 1 ms may be referred to as, for example, a general TTI (TTIs according to 3GPP Rel. 8 to 12), a normal TTI, a long TTI, a general subframe, a normal subframe, a long subframe or a slot. A TTI shorter than the general TTI may be referred to as, for example, a reduced TTI, a short TTI, a partial or fractional TTI, a reduced subframe, a short subframe, a mini slot, a subslot or a slot.

In addition, the long TTI (e.g., the general TTI or the subframe) may be read as a TTI having a time duration exceeding 1 ms, and the short TTI (e.g., the reduced TTI) may be read as a TTI having a TTI length less than the TTI length of the long TTI and equal to or more than 1 ms.

A Resource Block (RB) is a resource allocation unit of the time domain and the frequency domain, and may include one or a plurality of contiguous subcarriers in the frequency domain. The numbers of subcarriers included in RBs may be the same irrespectively of a numerology, and may be, for example, 12. The numbers of subcarriers included in the RBs may be determined based on the numerology.

Furthermore, the RB may include one or a plurality of symbols in the time domain or may have the length of 1 slot, 1 mini slot, 1 subframe or 1 TTI. 1 TTI or 1 subframe may each include one or a plurality of resource blocks.

In this regard, one or a plurality of RBs may be referred to as, for example, a Physical Resource Block (Physical RB (PRB)), a Sub-Carrier Group (SCG), a Resource Element Group (REG), a PRB pair or an RB pair.

Furthermore, the resource block may include one or a plurality of Resource Elements (REs). For example, 1 RE may be a radio resource domain of 1 subcarrier and 1 symbol.

A Bandwidth Part (BWP) (that may be referred to as, for example, a partial bandwidth) may mean a subset of contiguous common Resource Blocks (common RBs) for a given numerology in a given carrier. In this regard, the common RB may be specified by an RB index based on a common reference point of the given carrier. A PRB may be defined based on a given BWP, and may be numbered in the given BWP.

The BWP may include a UL BWP (a BWP for UL) and a DL BWP (a BWP for DL). One or a plurality of BWPs in 1 carrier may be configured to the UE.

At least one of the configured BWPs may be active, and the UE may not assume to transmit and receive given signals/channels outside the active BWP. In addition, a “cell” and a “carrier” in the present disclosure may be read as a “BWP”.

In this regard, structures of the above-described radio frame, subframe, slot, mini slot and symbol are only exemplary structures. For example, configurations such as the number of subframes included in a radio frame, the number of slots per subframe or radio frame, the number of mini slots included in a slot, the numbers of symbols and RBs included in a slot or a mini slot, the number of subcarriers included in an RB, the number of symbols in a TTI, a symbol length and a Cyclic Prefix (CP) length can be variously changed.

Furthermore, the information and the parameters described in the present disclosure may be expressed by using absolute values, may be expressed by using relative values with respect to given values or may be expressed by using other corresponding information. For example, a radio resource may be instructed by a given index.

Names used for parameters in the present disclosure are in no respect restrictive names. Furthermore, numerical expressions that use these parameters may be different from those explicitly disclosed in the present disclosure. Various channels (such as the PUCCH and the PDCCH) and information elements can be identified based on various suitable names. Therefore, various names assigned to these various channels and information elements are in no respect restrictive names.

The information and the signals described in the present disclosure may be expressed by using one of various different techniques. For example, the data, the instructions, the commands, the information, the signals, the bits, the symbols and the chips mentioned in the above entire description may be expressed as voltages, currents, electromagnetic waves, magnetic fields or magnetic particles, optical fields or photons, or arbitrary combinations of these.

Furthermore, the information and the signals can be output at least one of from a higher layer to a lower layer and from the lower layer to the higher layer. The information and the signals may be input and output via a plurality of network nodes.

The input and output information and signals may be stored in a specific location (e.g., memory) or may be managed by using a management table. The information and signals to be input and output can be overridden, updated or additionally written. The output information and signals may be deleted. The input information and signals may be transmitted to other apparatuses.

Notification of information is not limited to the aspects/embodiment described in the present disclosure and may be performed by using other methods. For example, the information may be notified in the present disclosure by a physical layer signaling (e.g., Downlink Control Information (DCI) and Uplink Control Information (UCI)), a higher layer signaling (e.g., a Radio Resource Control (RRC) signaling, broadcast information (such as a Master Information Block (MIB) and a System Information Block (SIB)), and a Medium Access Control (MAC) signaling), other signals or combinations of these.

In addition, the physical layer signaling may be referred to as Layer 1/Layer 2 (L1/L2) control information (L1/L2 control signal) or L1 control information (L1 control signal). Furthermore, the RRC signaling may be referred to as an RRC message, and may be, for example, an RRCConnectionSetup message or an RRCConnectionReconfiguration message. Furthermore, the MAC signaling may be notified by using, for example, an MAC Control Element (MAC CE).

Furthermore, notification of given information (e.g., notification of “being X”) is not limited to explicit notification, and may be given implicitly (by, for example, not giving notification of the given information or by giving notification of another information).

Judgement may be made based on a value (0 or 1) expressed as 1 bit, may be made based on a boolean expressed as true or false or may be made by comparing numerical values (by, for example, making comparison with a given value).

Irrespectively of whether software is referred to as software, firmware, middleware, a microcode or a hardware description language or is referred to as other names, the software should be widely interpreted to mean a command, a command set, a code, a code segment, a program code, a program, a subprogram, a software module, an application, a software application, a software package, a routine, a subroutine, an object, an executable file, an execution thread, a procedure or a function.

Furthermore, software, commands and information may be transmitted and received via transmission media. When, for example, the software is transmitted from websites, servers or other remote sources by using at least ones of wired techniques (e.g., coaxial cables, optical fiber cables, twisted pairs and Digital Subscriber Lines (DSLs)) and radio techniques (e.g., infrared rays and microwaves), at least ones of these wired techniques and radio techniques are included in a definition of the transmission media.

The terms “system” and “network” used in the present disclosure can be interchangeably used. The “network” may mean an apparatus (e.g., base station) included in the network.

In the present disclosure, terms such as “precoding”, a “precoder”, a “weight (precoding weight)”, “Quasi-Co-Location (QCL)”, a “Transmission Configuration Indication state (TCI state)”, a “spatial relation”, a “spatial domain filter”, “transmission power”, “phase rotation”, an “antenna port”, an “antenna port group”, a “layer”, “the number of layers”, a “rank”, a “resource”, a “resource set”, a “resource group”, a “beam”, a “beam width”, a “beam angle”, an “antenna”, an “antenna element” and a “panel” can be interchangeably used.

In the present disclosure, terms such as a “Base Station (BS)”, a “radio base station”, a “fixed station”, a “NodeB”, an “eNodeB (eNB)”, a “gNodeB (gNB)”, an “access point”, a “Transmission Point (TP)”, a “Reception Point (RP)”, a “Transmission/Reception Point (TRP)”, a “panel”, a “cell”, a “sector”, a “cell group”, a “carrier” and a “component carrier” can be interchangeably used. The base station is also referred to as terms such as a macro cell, a small cell, a femtocell or a picocell.

The base station can accommodate one or a plurality of (e.g., three) cells. When the base station accommodates a plurality of cells, an entire coverage area of the base station can be partitioned into a plurality of smaller areas. Each smaller area can also provide a communication service via a base station subsystem (e.g., indoor small base station (Remote Radio Head (RRH))). The term “cell” or “sector” indicates part or the entirety of the coverage area of at least one of the base station and the base station subsystem that provide a communication service in this coverage.

In the present disclosure, the terms such as “Mobile Station (MS)”, “user terminal”, “user apparatus (UE: User Equipment)” and “terminal” can be interchangeably used.

The mobile station is also referred to as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client or some other appropriate terms in some cases.

At least one of the base station and the mobile station may be referred to as, for example, a transmission apparatus, a reception apparatus or a radio communication apparatus. In addition, at least one of the base station and the mobile station may be, for example, a device mounted on a moving object or the moving object itself. The moving object may be a vehicle (e.g., a car or an airplane), may be a moving object (e.g., a drone or a self-driving car) that moves unmanned or may be a robot (a manned type or an unmanned type). In addition, at least one of the base station and the mobile station includes an apparatus, too, that does not necessarily move during a communication operation. For example, at least one of the base station and the mobile station may be an Internet of Things (IoT) device such as a sensor.

Furthermore, the base station in the present disclosure may be read as the user terminal. For example, each aspect/embodiment of the present disclosure may be applied to a configuration where communication between the base station and the user terminal is replaced with communication between a plurality of user terminals (that may be referred to as, for example, Device-to-Device (D2D) or Vehicle-to-Everything (V2X)). In this case, the user terminal 20 may be configured to include the functions of the above-described base station 10. Furthermore, words such as “uplink” and “downlink” may be read as a word (e.g., a “side”) that matches terminal-to-terminal communication. For example, the uplink channel and the downlink channel may be read as side channels.

Similarly, the user terminal in the present disclosure may be read as the base station. In this case, the base station 10 may be configured to include the functions of the above-described user terminal 20.

In the present disclosure, operations performed by the base station are performed by an upper node of this base station depending on cases. Obviously, in a network including one or a plurality of network nodes including the base stations, various operations performed to communicate with a terminal can be performed by base stations, one or more network nodes (that are regarded as, for example, Mobility Management Entities (MMEs) or Serving-Gateways (S-GWs), yet are not limited to these) other than the base stations or a combination of these.

Each aspect/embodiment described in the present disclosure may be used alone, may be used in combination or may be switched and used when carried out. Furthermore, orders of the processing procedures, the sequences and the flowchart according to each aspect/embodiment described in the present disclosure may be rearranged unless contradictions arise. For example, the method described in the present disclosure presents various step elements by using an exemplary order and is not limited to the presented specific order.

Each aspect/embodiment described in the present disclosure may be applied to Long Term Evolution (LTE), LTE-Advanced (LTE-A), LTE-Beyond (LTE-B), SUPER 3G, IMT-Advanced, the 4th generation mobile communication system (4G), the 5th generation mobile communication system (5G), Future Radio Access (FRA), the New-Radio Access Technology (RAT), New Radio (NR), New radio access (NX), Future generation radio access (FX), the Global System for Mobile communications (GSM (registered trademark)), CDMA2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other appropriate radio communication methods, or next-generation systems that are enhanced based on these systems. Furthermore, a plurality of systems may be combined (for example, LTE or LTE-A and 5G may be combined) and applied.

The phrase “based on” used in the present disclosure does not mean “based only on” unless specified otherwise. In other words, the phrase “based on” means both of “based only on” and “based at least on”.

Every reference to elements that use names such as “first” and “second” used in the present disclosure does not generally limit the quantity or the order of these elements. These names can be used in the present disclosure as a convenient method for distinguishing between two or more elements. Hence, the reference to the first and second elements does not mean that only two elements can be employed or the first element should precede the second element in some way.

The term “deciding (determining)” used in the present disclosure includes diverse operations in some cases. For example, “deciding (determining)” may be considered to “decide (determine)” judging, calculating, computing, processing, deriving, investigating, looking up, search and inquiry (e.g., looking up in a table, a database or another data structure), and ascertaining.

Furthermore, “deciding (determining)” may be considered to “decide (determine)” receiving (e.g., receiving information), transmitting (e.g., transmitting information), input, output and accessing (e.g., accessing data in a memory).

Furthermore, “deciding (determining)” may be considered to “decide (determine)” resolving, selecting, choosing, establishing and comparing. That is, “deciding (determining)” may be considered to “decide (determine)” some operation.

Furthermore, “deciding (determining)” may be read as “assuming”, “expecting” and “considering”.

“Maximum transmit power” disclosed in the present disclosure may mean a maximum value of transmit power, may mean the nominal UE maximum transmit power, or may mean the rated UE maximum transmit power.

The words “connected” and “coupled” used in the present disclosure or every modification of these words can mean every direct or indirect connection or coupling between 2 or more elements, and can include that 1 or more intermediate elements exist between the two elements “connected” or “coupled” with each other. The elements may be coupled or connected physically or logically or by a combination of these physical and logical connections. For example, “connection” may be read as “access”.

It can be understood in the present disclosure that, when connected, the two elements are “connected” or “coupled” with each other by using 1 or more electric wires, cables or printed electrical connection, and by using electromagnetic energy having wavelengths in radio frequency domains, microwave domains or (both of visible and invisible) light domains in some non-restrictive and non-comprehensive examples.

A sentence that “A and B are different” in the present disclosure may mean that “A and B are different from each other”. In this regard, the sentence may mean that “A and B are each different from C”. Words such as “separate” and “coupled” may be also interpreted in a similar way to “different”.

In a case where the words “include” and “including” and modifications of these words are used in the present disclosure, these words intend to be comprehensive similar to the word “comprising”. Furthermore, the word “or” used in the present disclosure intends to not be an exclusive OR.

In a case where, for example, translation adds articles such as a, an and the in English in the present disclosure, the present disclosure may include that nouns coming after these articles are plural.

The invention according to the present disclosure has been described in detail above. However, it is obvious for a person skilled in the art that the invention according to the present disclosure is not limited to the embodiment described in the present disclosure. The invention according to the present disclosure can be carried out as modified and changed aspects without departing from the gist and the scope of the invention defined based on the recitation of the claims. Accordingly, the description of the present disclosure is intended for exemplary explanation, and does not bring any restrictive meaning to the invention according to the present disclosure.

1. A user terminal comprising:
a receiving section that receives first downlink control information and second downlink control information, the first downlink control information including a first transmit power control command for a first type uplink channel, and the second downlink control information including a second transmit power control command for a second type uplink channel; and
a control section that, in a case where a transmission timing of the second downlink control information is later than a transmission timing of the first downlink control information, and a transmission timing of the first type uplink channel is later than a transmission timing of the second type uplink channel, controls accumulation of the first transmit power control command and the second transmit power control command based on at least one of an uplink channel type, a power control adjustment state index, a downlink control information transmission timing and an uplink channel transmission timing.

2. The user terminal according to claim 1, wherein the control section controls to separately accumulate the first transmit power control command and the second transmit power control command.

3. The user terminal according to claim 1, wherein the control section determines transmission power for the first type uplink channel based on accumulation of the first transmit power control command, and determines transmission power for the second type uplink channel based on accumulation of the first transmit power control command and the second transmit power control command.

4. The user terminal according to claim 1, wherein the control section determines transmission power for the first type uplink channel and the second type uplink channel based on accumulation of the first transmit power control command and the second transmit power control command.

5. The user terminal according to claim 1, wherein the control section controls accumulation of the first transmit power control command and the second transmit power control command in a case where the transmission timing of the second downlink control information is later than the transmission timing of the first downlink control information, and the transmission timing of the second type uplink channel is later than the transmission timing of the first type uplink channel, and accumulation of the first transmit power control command and the second transmit power control command in a case where the transmission timing of the second downlink control information is later than the transmission timing of the first downlink control information, and the transmission timing of the first type uplink channel is later than the transmission timing of the second type uplink channel by different methods.

6. A radio communication method comprising:
receiving first downlink control information and second downlink control information, the first downlink control information including a first transmit power control command for a first type uplink channel, and the second downlink control information including a second transmit power control command for a second type uplink channel; and
in a case where a transmission timing of the second downlink control information is later than a transmission timing of the first downlink control information, and a transmission timing of the first type uplink channel is later than a transmission timing of the second type uplink channel, controlling accumulation of the first transmit power control command and the second transmit power control command based on at least one of an uplink channel type, a power control adjustment state index, a downlink control information transmission timing and an uplink channel transmission timing.

7. The user terminal according to claim 2, wherein the control section controls accumulation of the first transmit power control command and the second transmit power control command in a case where the transmission timing of the second downlink control information is later than the transmission timing of the first downlink control information, and the transmission timing of the second type uplink channel is later than the transmission timing of the first type uplink channel, and accumulation of the first transmit power control command and the second transmit power control command in a case where the transmission timing of the second downlink control information is later than the transmission timing of the first downlink control information, and the transmission timing of the first type uplink channel is later than the transmission timing of the second type uplink channel by different methods.

8. The user terminal according to claim 3, wherein the control section controls accumulation of the first transmit power control command and the second transmit power control command in a case where the transmission timing of the second downlink control information is later than the transmission timing of the first downlink control information, and the transmission timing of the second type uplink channel is later than the transmission timing of the first type uplink channel, and accumulation of the first transmit power control command and the second transmit power control command in a case where the transmission timing of the second downlink control information is later than the transmission timing of the first downlink control information, and the transmission timing of the first type uplink channel is later than the transmission timing of the second type uplink channel by different methods.

9. The user terminal according to claim 4, wherein the control section controls accumulation of the first transmit power control command and the second transmit power control command in a case where the transmission timing of the second downlink control information is later than the transmission timing of the first downlink control information, and the transmission timing of the second type uplink channel is later than the transmission timing of the first type uplink channel, and accumulation of the first transmit power control command and the second transmit power control command in a case where the transmission timing of the second downlink control information is later than the transmission timing of the first downlink control information, and the transmission timing of the first type uplink channel is later than the transmission timing of the second type uplink channel by different methods.
